(19) United States
(12) Patent Application Publication
(10) Pub. No.: US 2016/0044271 A1
(43) Pub. Date: Feb. 11, 2016

(54) UNIVERSAL REMOTE CONTROL FOR EFFECTING THE SAME FUNCTION ON A PLURALITY OF DIFFERENT DEVICES

(71) Applicant: Mitchell A. Altman, San Francisco, CA (US)

(72) Inventor: Mitchell A. Altman, San Francisco, CA (US)

(21) Appl. No.: 14/453,405

(22) Filed: Aug. 6, 2014

(51) Int. Cl. H04N 5/44

(52) U.S. Cl. CPC H04N 5/4403

(57) ABSTRACT

A universal remote control device effects a same function on a plurality of different remotely controlled devices. The device has a housing, an actuator within the housing, a database of encoded signals for effecting the same function on the plurality of different remotely controlled devices; and a signal emitter configured to emit the encoded signals so as to effect the same function for each of the plurality of different devices in response to actuation of the actuator with no more than ½ second between each encoded signal.

### BACKGROUND OF THE INVENTION

1. Field of the Invention

The present invention relates to a device that controls the same function for a plurality of different electronically remote controlled devices. In certain preferred embodiments, the function is powering off, muting or muting and closed captioning a plurality of television sets or DVD players.

2. Description of the Related Art

A particularly annoying problem often occurs while trying to have a conversation in a location where a TV is powered on. When a television set is turned on, even if the volume is muted, it seems to demand everyone's attention, making it difficult to pay attention to conversation, or other more useful activities. Even while by oneself, a television set which is powered on has deleterious affects which are minimized when the television set is powered off.

Universal remote control devices have been made for replacement of original remote controls or for controlling a plurality of different types of devices. Some of these universal remote control devices have a mode for determining the proper emission signals for carrying out various functions on the particular devices desired to be controlled. In this mode, the universal control device will emit a sequence of power control signals for a plurality of different makes and models of a particular device, such as a television set. When the particular device responds to the signal, the user of this type of universal remote control device will push a button to indicate that the proper signal has been reached. In this manner, the universal remote control device is programmed for the particular device. In order to provide sufficient time for the user to react, this mode generally includes a pause of approximately three seconds between signals.

### SUMMARY OF THE INVENTION

One aspect of the present invention relates to a universal remote control device for effecting a same function on a plurality of different remotely controlled devices. In preferred embodiments, the function is to power the device off or to mute the device. There may be only a single function effected by the device. Preferably the device effects the same function on at least five different remotely controlled devices, and even more preferably at least ten or twenty different remotely controlled devices. The devices affected can be any of a variety of remotely controlled devices, including televisions, stereos, satellite controllers or video players, such as VCR or DVD players.

The device includes a housing (or enclosure), an actuator within the housing, a database of encoded signals for effecting the same function on said plurality of different remotely controlled devices, and a signal emitter. In one preferred embodiment, the device is in the form of a key chain. The housing can be configured to resemble a smiley face. In this preferred embodiment, the actuator can be a button on the smiley face and each of the eyes can be a signal emitter. The signal emitter can be an infrared (JR) light emitting diode (LED). The signal emitter is configured to emit the encoded signals so as to effect the same function for each of the plurality of different devices in response to actuation of the actuator with no more than ½ second between each encoded signal. Preferably, there is no more than ¼ second between each signal, and still more preferably there is no more than 1/10 second between signals.

Another aspect of the present invention relates to a method for effecting a function of a remotely controlled device. The function effected can be any function, including those described in connection with the first aspect of the invention. The method includes pointing a universal remote device in the direction of the remotely controlled device. The universal remote device used in the method includes a database of encoded signals for effecting the function on a plurality of different remotely controlled devices. After pointing, an actuator on the universal remote device is actuated. This causes the device to send the encoded signals from the database to a signal emitter on the universal remote device. The encoded signals from the signal emitter are then emitted so as to effect the function on the remotely controlled device. Preferably, there is no more than ½ second between each emitted signal, more preferably no more than ¼ second, and still more preferably no more than 1/10 second. The signals emitted can be infrared light. Preferably, the encoded signals are sent only a single time to the signal emitter. Advantageously, the method can be repeated again and again without selecting a set of encoded signals for the universal remote device. In certain preferred embodiments, when the method is repeated on the same device, the function is reversed, such as when the device is first powered off and then powered back on.

### BRIEF DESCRIPTION OF THE DRAWINGS

FIG. 1 is a depiction of a preferred embodiment of the device of the present invention showing 2 IR LEDs (1) and a push-button switch (2), on a 3″ diameter smiley-face pin (3). Also shown are two television sets (4) being powered off by the device of the present invention.

FIG. 2 shows a block diagram of hardware for a means of acquiring power code data from a television remote control.

FIG. 3 shows a flow chart of an algorithm for controlling firmware for a data acquisition board which uses an ST10 microcontroller, for capturing encoded power signals from a universal remote control.

FIG. 4 shows an example of an encoded power signal as analyzed by the Extended Decoding Software.

FIG. 5 shows the definition of the bits that make up the code_type byte for entries within the database of encoded power signals.

FIG. 6 shows the general form of each database entry for all encoded power signals.

FIG. 7 shows an example of an encoded power signal with certain qualities as analyzed by the Extended Decoding Software, ready to be characterized for creating an entry for it in the database of encoded power signals.

FIG. 8 shows an example of an encoded power signal with certain qualities as analyzed by the Extended Decoding Software, ready to be characterized for creating an entry for it in the database of encoded power signals.

FIG. 9 shows a schematic diagram of the electronics of the preferred embodiment of FIG. 1.

FIG. 10A is a flow chart of the main routine of the firmware used in the microcontroller shown in the schematic diagram of FIG. 9.

FIG. 10B (divided into 10B₁ through 10B₅) shows a flow chart of get_and_xmit_next_code, a subroutine of the firmware of FIG. 10A, that gets and transmits the next code from code_tab, the database of codes stored in the ROM inside of the microcontroller shown in the schematic diagram of FIG. 9.

FIG. 10C (divided into 10C₁ through 10C₃) shows a flow chart of xmit_code_sequence, a subroutine of the firmware of FIG. 10B, that gets and transmits a code's Main Sequence from code_tab.

FIG. 10D (divided into 10D₁ through 10D₂) shows a flow chart of xmit_hold_down_sequence, a subroutine of the firmware of FIG. 10B, that gets and transmits the code's Hold-Down Sequence from code_tab.

FIG. 10E shows a flow chart of get_next_on_off_times, a subroutine of the firmware of FIG. 10B and FIG. 10C, that gets the next On-Time and Off-Time within the code's Main Sequence from the code_tab.

FIG. 10F shows a flow chart of point_to_next_time_tab_entry, a subroutine of the firmware of FIG. 10E, that points to the appropriate entry in time_tab, as determined by the next nybble from the Sequence nybbles in code_tab.

FIG. 10G shows a flow chart of start_gating_timer, a subroutine of the firmware of FIG. 10B, that that starts the Gating Timer going inside of the microcontroller shown in the schematic diagram of FIG. 9.

FIG. 10H shows a flow chart of send_on_off_times_to_gating_timer, a subroutine of the firmware of FIG. 10C and FIG. 10D, that that sends the next On-Time and Off-Time to the Gating Timer inside of the microcontroller shown in the schematic diagram of FIG. 9.

### DETAILED DESCRIPTION OF THE PREFERRED EMBODIMENT

### Introduction

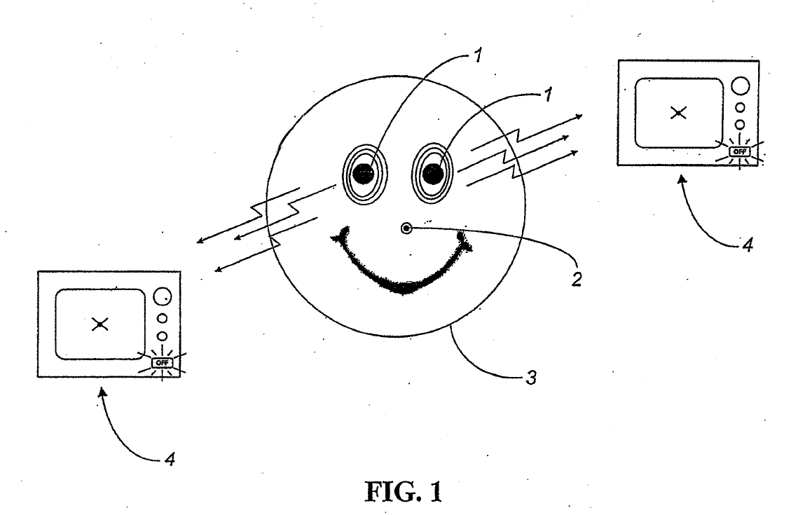

I developed the invention on the premise that it would be great to have a device that turns off any distracting TV that one comes across. I have created that device, and I call it, the “TV-B-Gone” device. In a preferred embodiment, the device is configured as a “smiley-face” pin, similar to what was popular during the 1970s. One or more of the “eyes” of the smiley-face can be an emitting device, as described in more detail below. The smiley-face can have a “nose” that is actually a push button that activates the device of the present invention. A depiction of the smiley-face embodiment of the device of the present invention is shown in FIG. 1, showing 2 IR LEDs (1) for the “eyes” and a push-button switch (2) for the “nose”, on a 3″ diameter smiley-face pin (3). Also shown are two television sets (4) being powered off. However, of course, the aesthetics of the device can be configured into any packaging desired. For example, the device can be configured as a key-chain shaped to look like a miniature TV remote control. Or it may be configured for novelty advertising, such as for non-TV media outlets. The device need not be limited to any shape, as the packaging can take any of a variety of shapes, limited only by the ability to create appropriate packaging.

What the Device of the Present Invention does

The device of the present invention is a special kind of television remote control that cycles through all of the television remote control power codes for a plurality of television remote controls. In a preferred embodiment, the number of power codes is maximized so that a majority of television receiving devices can be powered off. In this way, it will turn off virtually any TV in the vicinity of the device of the present invention. Advantageously, the device can be worn by any person desiring to achieve this effect. However, it is possible to include other functions besides power-control into the device of the present invention; and it is also possible to remotely control other devices. For example, a device of the present invention could be made to mute television sets, or to mute and closed caption DVD players. Solely for convenience of description, the device of the present invention will be described hereinbelow in connection with powering television sets off. From this description, those having ordinary skill in the art can readily modify the device for other functions besides power-control and for other types of devices besides television sets.

### How the Device of the Present Invention Works

The device of the present invention is a device that is very much like a television remote control, but different in one major respect. A normal TV remote control is intended to work on one television set, and it is able to remotely control all of the functions for that one television set (such as power, channel, volume, mute, etc.). The device of the present invention is intended to work on all television sets, and, in its preferred embodiment, is only able to remotely control the power for all of those television sets. In other words, in its preferred embodiment, the device of the present invention is intended to remotely turn off virtually any and all remotely controlled television sets—and nothing more (so it only remotely controls power). Otherwise, the device of the present invention is very much like a normal TV remote control.

Both the device of the present invention and virtually all modern, normal TV remote controls use Infra-Red (IR) light to transmit encoded remote control signals to television sets. To the extent that other technologies in TV remote control are used and/or developed, the device of the present invention can be readily modified to emit the appropriate non-IR signal to power off these remote-controlled devices. However, solely for convenience of description, the device will be described hereinbelow in connection with IR-based remote controls. From this description, those having ordinary skill in the art can readily modify the device for non-IR-based remote controls.

Each television set with IR remote control capability has an JR receiver that decodes the encoded a light signal from the TV remote control, and if it can successfully decode a received signal, it then performs the task that the IR signal was encoded to perform (such as power, channel, volume, etc.).

The device of the present invention sends out, in sequence, the encoded power signals (which will turn a TV on or off) for a plurality of TV remote controls, one encoded power signal following the other. After sending the complete sequence of encoded power signals, the device of the present invention can then turns itself off. In this way, it will turn off any and all remotely controllable television sets in the vicinity that respond to the signals emitted by the device of the present invention.

One possible mode of operation idea for triggering the action of the device of the present invention is to have it “listen” for the 15 KHz squeal that most North American television sets create when they are powered on. For example, a transducer that responds to 15 KHz can be provided. The 15 KHz frequency is necessary for all NTSC television sets with a CRT. Whenever the device detects 15 KHz, this triggers the device of the present invention to output, through its IR LED, the sequence of all of all of the television set remote controls it encodes. The device can be configured to “listen” to a different frequency for video standards other than NTSC, as will be readily appreciated by those skilled in the art.

Alternatively, the device of the present invention can be configured to be triggered by a simple (and inexpensive) push-button switch. In the smiley-face embodiment, the push-button can be provided as one of the “eyes” or as a “nose.” One advantage of this configuration is that the device can be manufactured as inexpensively as possible. Another advantage is that with a push-button switch there is no limitation as to the video standard of the television sets that can be remotely turned off, such as NTSC or PAL. Moreover, displays that do not emit a particular frequency squeal, such as plasma or LCD can also be powered off. Thus, the device of the present invention configured for manual triggering of IR signals can turn off virtually any television set that uses IR remote control.

In the manually-triggered device, when the push-button is pushed, the device of the present invention emits a sequence of all of the encoded power signals in its database. It emits this sequence only once—this is because the same power code will turn a given television set off if the television set is on, or off if the television set is on. And the intent is to turn the TV off, and keep it off.

In the preferred embodiment, the “smiley-face” has two Infra-Red LEDs, one for each “eye”. To make it easy for a user of a device of the present invention to turn off television sets in their vicinity without needing to be conscious of pointing the device, one LED “eye” can have a relatively narrow radiation angle of about 15 degrees, and the other can have a relatively broad radiation angle of about 25 degrees.

In many unfortunate situations, there is a plurality of television sets at a single location. Advantageously, the device of the present invention can effectively turn off all of the television sets capable of responding to the signals it emits. In the event that some of the television sets are powered on and others are powered off, the user of the device of the present invention can direct the signals towards those sets that are powered on and block the emission of signals towards those that are powered off. This blocking of emissions can be accomplished simply by blocking the signal with one's hand or any other convenient material that is opaque to IR light. In other preferred embodiments, the IR-emitting device can be configured using emitters with a narrow radiation angle, and the user can point the device of the present invention towards a particular television set that is powered on. Thus, any other television sets will not receive the signal from the device of the present invention and so will not be affected.

When sending out the sequence of encoded power signals, it is preferable to have a delay of about 250 millisec. between each signal. In this way, the device of the present invention ensures that no IR remote receiver on any television set will get confused by being in the vicinity of so many different encoded power signals—it will only respond to the power code that will turn its power off.

### The Database of Encoded Power Signals

In an ideal embodiment, the encoded power signals for every remote control ever made would be included within the database of encoded power signals. However, in view of the sheer number of possible codes, as many as possible of the encoded power signals are preferably included. This task could be accomplished in a variety of ways. For example, many websites on the internet exist that include published information on remote controls. Additionally, a number of universal remote controls are made that contain their own databases of encoded signals. Of these, only the encoded power signals for television sets need be obtained. The encoded power signals of the universal remote controls can be obtained through a data acquisition system. A preferred data acquisition system comprises a data acquisition board plugged into a computer, firmware running on the data acquisition board, and software to control the data acquisition board and store the data. A means of using a data acquisition system to obtain encoded power signals is described in its own section, below.

As of the priority date of the present application, additional information concerning the generation of the encoded power signals can be obtained from www.zilog.com/docs/ir/appnotes/an0046.pdf, the complete disclosure of which is hereby incorporated by this reference thereto. Permission to use the codes described at that site can be obtained from Zilog, Inc. of Campbell, Calif. or from a local Zilog Sales Office. Those skilled in the art can readily rearrange the firmware (which can be downloaded from www.zilog.com/docs/ir/appnotes/an0046-sc-01.zip) to suit the needs of the device of the present invention: e.g., send out a sequence of encoded power signals separated by 250 millisec. gaps and then turn itself off.

In creating the database of encoded power signals, it is advantageous to amass as many as possible encoded power signals. In a preferred embodiment I combined the encoded power signals acquired from 2 different universal IR remote controls, plus those obtained and licensed through Zilog, Inc., plus some obtained from various websites.

In creating the database of encoded power signals, it is important to have no duplicates entries. This is because the power code for most remotely controlled television sets is the same for On or Off (if the TV is off, it will turn itself on if it detects a power signal—if the TV is on, it will turn itself off if it detects a power signal). If there were a duplicate entry in the database, then when the device of the present invention is sending out its sequence of power signals, the first entry will turn the TV off, and the second entry will turn the TV back on, which is undesirable.

The requirement of having no duplicate entries in the database is more difficult to achieve than it may seem at first glance. When acquiring data, there is a margin of error in the measurements, so no two acquired encoded power signals are likely to be exactly the same, making it difficult to determine that they are the same. Moreover, many encoded power signals are similar but not exactly the same—but they may be close enough to be interpreted as the same by different television sets' IR remote receivers. The process used to delete duplicate entries in a device of the present invention prototype is described within the section on acquiring encoded power signals from a universal IR remote control, below.

However they are obtained, once the encoded power signals are obtained, they need to be put into a form that is compact so that many codes may be stored in a small amount of storage (such as ROM in a microcontroller). A method for characterizing encoded power signal data for compact storage in a database of encoded power signals is described in its own section, below, after describing acquisition of encoded power signals from universal IR remote controls.

Acquisition of Encoded Power Signals from Universal IR Remote Controls

Though the acquiring of the encoded power signals is not part of this invention, for the invention to be useful these encoded power signals must somehow be acquired and entered into the invention. This section describes one method of acquiring encoded power signals from universal IR remote controls for use in the device of the present invention. There are, of course, many other means towards the same end. The analysis required for eliminating duplicate encoded power signals from those acquired, described later in this section, is also directly applicable for reducing the amount of storage necessary for the device of the present invention's database of encoded power signals (which is described later in its own section).

The process of acquiring encoded power signals from universal IR remote controls is broken into three parts:

1. Acquiring the data

2. Analyzing the data

3. Eliminating duplicates

Each of these will be described below.

### 1. Acquiring the Data

To acquire an encoded power signal from a universal IR remote control, we need access to the digital signal and ground from e universal JR remote control. These are obtained by opening the remote control, soldering a wire to the output of the device inside that sends the signal to its IR LED (usually this is a microcontroller), and soldering a wire to the ground side of the battery connector. Signal and ground are then input to a data acquisition system.

The data acquisition system consists of the following 3 components: a universal IR remote control connected, through signal-conditioning circuitry, to a data acquisition board that plugs into a hardware slot on a computer (such as a PC's PCI slot); firmware on the data acquisition board to control acquiring of the data; software running on the computer (such as a PC) to control the data acquisition board, and to retrieve and format the acquired data from the data acquisition board.

Data acquisition boards are widely available for purchase from a variety of sources. Many are acceptable for this project—the main thing being the ability to accurately time periods between all edges of a digital signal with periods between about 1 microsec. and 2 sec. I used a data acquisition board with an ST10 microcontroller that has two built-in 32-bit timers with a resolution of 160 nanosec.—this means that each of these timers can time a period of as little as 160 nanosec., time a period of 10 microsec. with an accuracy of +/−0.8%, and are capable of timing a period well past 2 sec. (it can time a period of up to 11.45 minutes).

To capture an encoded power signal from a universal IR remote control, the following overall procedure is used. First set up the universal IR remote control to control the desired make and model television set (this is done by following the instructions that come with the universal IR remote control). Then start the software on the PC that has the data acquisition board plugged into its PCI slot. The software tells the firmware on the data acquisition board to start. Once started, the firmware initializes the board's hardware and then waits for a digital signal on the board's input. After telling the firmware to start, the software then waits for the firmware to tell it that the firmware has completed its task of acquiring the encoded power signal. Now that the firmware is waiting for a signal on its input, the POWER button is pushed on the universal IR remote control, thus presenting a digital signal at the input of the data acquisition board, and the firmware starts acquiring the encoded power signal. The POWER button on the universal remote control must remain pushed down until the data acquisition board's firmware is finished acquiring the encoded power signal. To acquire the encoded power signal, the firmware times the digital signal on its input: starting with a Low, the firmware times from the first positive edge (Low-to-High transition) of the signal to the first negative (High-to-Low transition) of the signal and stores this value in the data acquisition board's RAM, thus acquiring the first High period. Then the first Low period is acquired by timing until the next positive edge of the signal, which it then stores in RAM. This continues till RAM on the data acquisition board is full, at which point the firmware tells the software running on the PC that the firmware is finished with its task. The software then retrieves the data from the data acquisition board's memory, converts the count data to nanoseconds, and formats the data into a text file which it saves to the PC's hard disk.

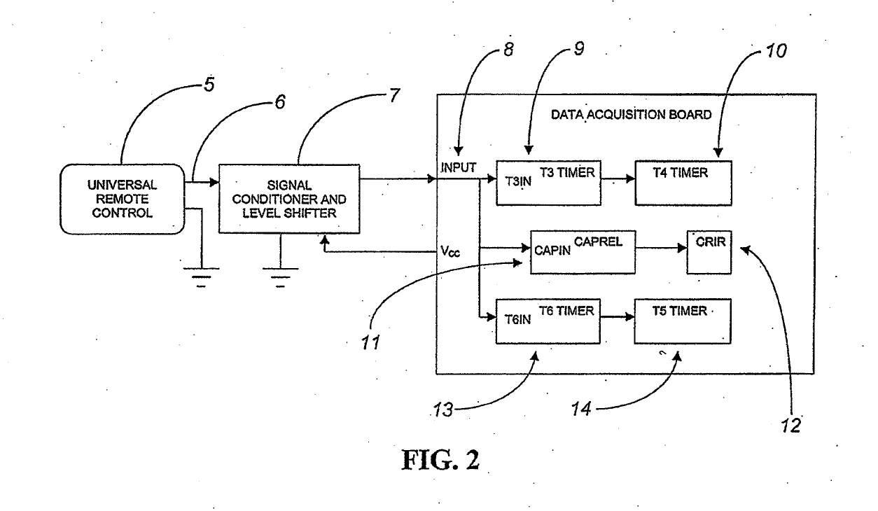

FIG. 2 shows a block diagram of the hardware for the data acquisition system I used to perform the procedure described above. The signal (6) from a universal IR remote control (5) is conditioned and shifted (7) to be a digital signal with the correct voltage for the data acquisition board's digital input (8). From there, the signal goes into 3 inputs on the data acquisition board: T3IN (9), CAPIN (11), T6IN (13), which are timer inputs on an ST10 microcontroller on the data acquisition board. CAPIN (11) is “Capture Input”, which is initialized to set the CRIR flag (12) on any edge (both positive and negative) of the digital signal going into it. T3IN (9) is the gate input to a 32-bit counter (with T3 (9) concatenated with T4 (10)) initialized to increment once every 160 nanosec. while T3IN (9) is High. T6IN (13) is the gate input to a 32-bit (with T6 (13) concatenated with T5 (14)) counter set up to increment once every 160 nanosec. while T6IN (13) is Low.

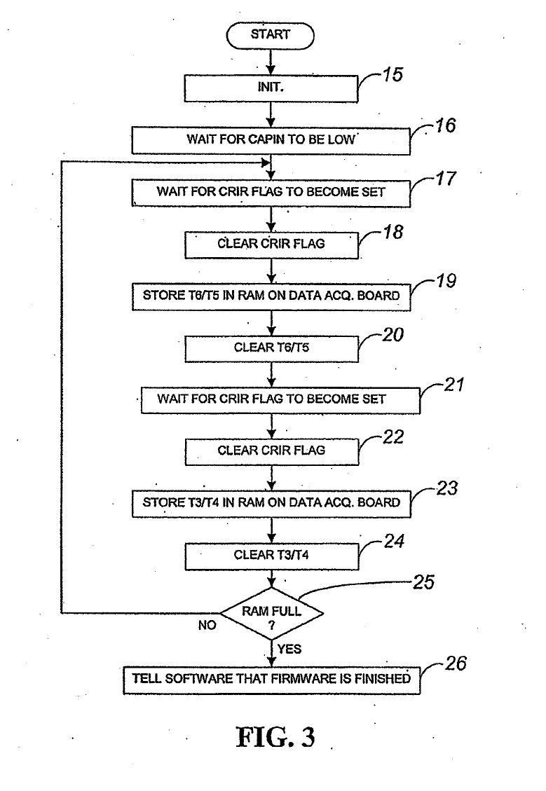

FIG. 3 shows a flow chart of the firmware algorithm. When told to do so by the software on the PC, the controlling firmware on the data acquisition board initializes the timers to perform the functions outlined above (15). The process needs to start with the digital input signal Low (16), since the output of any universal IR remote control is Low before pressing any buttons. The first time that the CRIR flag becomes set (17) is when the CAPIN input (11) has a positive edge (Low-to-High transition). When we store the contents of the 32-bit T6/T5 counter (19), we are storing the number of 160 nanosec. counts for the Low period which just ended. The CRIR flag must be cleared (18) by the firmware before it is ready to respond to the next edge at CAPIN (11). After storing the contents of T6/T5 counter (19), the counter must be cleared (20) so that it is ready to count for the next High period. The second time that the CRIR flag becomes set (21) is when the CAPIN input (11) has a negative edge (High-to-Low transition). When we store the contents of the 32-bit T3/T4 counter (23), we are storing the number of 160 nanosec. counts for the High period which just ended. The CRIR must be cleared (22) by the firmware before it is ready to respond to the next edge at CAPIN (11). After storing the contents of T3/T4 counter (23), the counter must be cleared (24) so that it is ready to count for the next High period. The sequence of waiting for edges and storing counts into RAM is repeated until is full (25), at which point the firmware tells the software that the firmware is finished with its task (26).

Those skilled in the art can readily implement the above firmware in the ST10's assembly language (or in the assembly language of the microcontroller on any appropriate data acquisition board).

When the firmware is finished, the RAM on the data acquisition board is full of timing data of the encoded power signal from the universal IR remote control.

The software on the PC does the following: tells the firmware to start acquiring data; waits for the firmware to finish its task; transfers the data from the data acquisition board's RAM to the PC's RAM; converts each count to nanoseconds by multiplying each value by 160; formats the data and stores it in a text file on the PC's hard drive.

Those skilled in the art can readily implement the above software (e.g., in the C or C++ programming language).

The above data acquisition procedure can be performed on all of the encoded television power signals contained in a universal IR remote control. That results in a set of text files stored on the PC's hard drive: one text file for each encoded power signal.

Table 1 shows an example of the first few lines of output of one text file (this text file is actually 4054 lines long).

TABLE 1

| Column 1 | Col. 2 |
|---|---|
| 8556489120 | 9280 |
| 7200 | 9280 |
| 7200 | 9440 |
| 7360 | 9280 |
| 7200 | 9280 |

The above data is interpreted as follows: the first entry of each line (Column 1) is the period (in nanosec.) that the encoded power signal is Low (the first entry on the first line is not useful since it times the length of time between when the software was started and when the POWER button was pressed on the universal IR remote control), the second entry of each line (Column 2) is the period (in nanosec.) that the encoded power signal is High. So, the few lines shown above represent 5 pulses of a square-wave with (ignoring the slight variation in some of the entries) a Low period of 7200 nanosec. and a High period of 9280 nanosec. (giving a frequency of 60.7 Khz).

### 2. Analyzing the Data

We now have a set of text files, one file for each encoded television power code contained in each universal IR remote control from which we acquired data. Each of these files contains up to thousands of lines of text representing a digital signal which is one encoded power signal. These files contain enough information to be able to reproduce the encoded power signals. But it would be extremely tedious to be able to try and find duplicate encoded power signals using these text files (imagine comparing several hundred of these text files with one another!). So, it is advantageous to create software to analyze the data in these files to help with the task of finding duplicate encoded power signals.

There are many ways to analyze the text files. The ideal way to analyze the files would be to create a software program that is a universal decoder of all possible power signal encodings—the output of such a program would give a list with one entry for each text file. Each entry of the list would contain the carrier frequency (explained below) and a hexadecimal number which represents the decoded power signal. Given that there are many, many different encodings for power signals, writing such a universal decoder would be a major project in itself. Fortunately, compromises of the ideal are possible that yield results that are good enough to aid in the finding of duplicate encodings for power signals. The analyzing program that I wrote, called Decoding Software, which uses such a compromise is described immediately, below.

After looking at hundreds of text files, I noticed that almost all of the encoded power signals follow a similar pattern. They start with several lines of “carrier frequency” followed by “encode bits”. The carrier frequency is several pulses of an unchanging (plus or minus some small degree of Measurement error) square-wave with a frequency between about 20 KHz and 70 KHz. For a given text file each line of text always has the same High period (plus or minus some small degree of measurement error), but may contain different length Low periods. An “encode bit” is made up of so many lines of carrier frequency, followed by one line with a significantly longer Low period. Furthermore, many text files revealed that the encoded power signal repeated itself after a long delay (i.e., the signal was Low for a long period, and then the encoded power signal repeated itself). I decided to decode text files that fit the above pattern using my own decoding scheme. The few text files that don't follow the above pattern can be checked by hand to see if there are any duplicates amongst them. It doesn't matter that my decoding scheme isn't the actual decoding used by the individual manufacturers of remote control devices since I'm only using my decoding scheme to help me find duplicate encoded power signals

In designing my decoding scheme, I kept the following in mind: if the Decoding Software gives a unique decoding for an encoded power signal then the power code is unique (however, it is possible that one encoded power signal may have a small number of encoded bits, and another encoded power signal may have larger number of encoded bits; and if the first encoded bits of the longer signal match all of the encoded bits of the shorter decoded signal, then it is possible that the longer power code may turn off the TV for the shorter code—we'll come back to this when describing the elimination of the duplicate power signals.). But if the Decoding Software gives a decoding that matches another (or matches several), it doesn't necessarily mean that the matching codes are duplicates—if there are matches, then I'd need to check the text files by hand to determine if they represent duplicate power signals or not.

The Decoding Software I wrote works in the following way. The Decoding Software throws away the first line of the text file since, as described earlier, it contains a Low value that isn't useful. The next 5 lines of the text file are checked to see if they contain an unchanging square wave (plus or minus some small degree of measurement error). Files for which there are not at least 5 lines of unchanging square-wave are flagged as “exceptions” that will need to be checked by hand. If the text file is not an exception, then the Decoding Software assumes that these first 5 lines of unchanging square-wave comprise the “carrier frequency” of the encoded power signal, and calculates: the average Low period for the carrier frequency, the average High period for the carrier frequency, and calculates the carrier frequency from these average Low and High periods. It then looks at the “encode bits” to decode the input text file.

In order to decode the “encode bits”, the following algorithm is applied. First, look through the entire text file to find all Low periods that are greater than 1000 nanosec. than the average Low period for the carrier frequency, and store them in a table—these are called “Long Low Periods”. Next, look through the table to find the lowest value of “Long Low Period”. All values of “Long Low Period” in the table that are less than 1.8 times this lowest value of “Long Low Period” will be called a ‘0’ bit. All values of “Long Low Period” in the table that are greater than or equal to 1.8 times this lowest value of “Long Low Period” will be called a ‘1’ bit. In order to shorten the number of decoded bits we'll ignore all bits after we get a “Long Low Period” greater than 6 times the lowest value (since we're only using the decoding to distinguish different codes, we don't need to decode the entire code). Then, so the results may be easily converted to a hexadecimal number, add binary ‘0’ bits at the least significant end of the decoded result so that the result has a multiple of 4 bits. Finally, add the decoded power signal result and the carrier frequency to a text file called “Decode.txt”.

The resultant “Decode.txt” file contains one line per original text file, each line containing: the input text file name, the decoded power signal for the input text file, and carrier frequency for the input text file. If the input text file does not contain at least 5 lines of unchanging square-wave at its beginning, then its entry in the Decode.txt file contains the word “exception” next to the input text file name.

Table 2 shows an example of a few lines of a Decode.txt file. Column 1 is the text file name, Column 2 is the hexadecimal decoding, and Column 3 is the carrier frequency.

TABLE 2

| Column 1 | Col. 2 | Col. 3 |
|---|---|---|
| code426.txt | C0E8 | 39.6 KHz |
| code427.txt | exception | |
| code428.txt | 08F710EF | 37.7 KHz |
| code429.txt | 3B7E | 33.8 KHz |

As an example of how the decoding scheme works, assume that the following table of “Long Low Periods” was taken from a text file for one of the captured encoded power signals:

94 93 94 218 218 94 218 218 94 536

93 is the lowest “Long Low Period”, so anything less than 1.8*93=167 is a binary ‘0’ bit, and everything else is a binary ‘1’ bit. So, the decoded power signal is (with two ‘0’ bits added at the least significant end): 0001, 1011, 0100 binary, which yields 1B4 hexadecimal as the decoded power signal.

Those skilled in the art can readily implement the above Decoding Software (e.g., in the C or C++) programming language).

### 3. Eliminating Duplicates

As mentioned earlier, we must not have any duplicate encodings of power signals in the device of the present invention's output sequence, otherwise a TV may turn on again after the device of the present invention turns the TV off, thus defeating the purpose of the device of the present invention.

Whether or not we acquired the encoded power signals from more than one universal IR remote control, we more than likely have some text files that represent duplicate encoded power signals. But, given the results from the Decoding Software in the Decode.txt file, we are ready to eliminate any possible duplicates, thus ensuring that the database we create will work in the device of the present invention in the manner intended (turning off television sets).

Remember, the Decoding Software doesn't eliminate the necessity of comparing some text files by hand, but it does greatly reduce the number necessary to compare by hand. For those text files for which it is necessary to compare by hand, one way to do so is to use a text editor with two files opened at a time whence you may flip between them back and forth. In this way, any values seen that are different by more than 10% should be indicative that the two text files represent unique encoded power signals. For instance, if the number of carrier frequency pulses in between Long Low Periods is different by more than 10%, then the encoded power signals can be considered unique; or, if some Long Low Periods are different by more than 10%, then the encoded power signals can be considered unique.

We can reduce the number of hand comparisons necessary by checking entries in the Decode.txt in the following way.

First check any text files flagged as “exceptions” by the Decoding Software (as noted in the Decode.txt file). It is easy enough to compare these text files by hand using a text editor to see if they represent the same encoded power signal.

Next, look at entries in the Decode.txt file that have matching decoded power signals results. If the carrier frequencies are different by more than 10%, then assume they are unique power signals. If the carrier frequencies are closer than 10%, then their text files must be compared by hand using a text editor.

All text files for which there is a uniquely decoded result from the Decoding Software probably represent a unique encoded power signal. However, as mentioned parenthetically earlier, it is possible that of two uniquely encoded power signals; one may still need to be eliminated. If one has an encoded power signal with a smaller number of decoded bits, and one is decoded with a larger number of decoded bits; and if the first decoded bits of the longer signal match all of the decoded bits of the shorter decoded signal, then it is possible that the longer power code may turn off the TV for the shorter code. For example, if a text file has a hexadecimal decoded result of 1234, and another text file yields a hexadecimal decoded result of 12345, then it is possible that the latter encoded power signal may turn off a TV that responds to 12345 as well as a TV that responds to 1234. If these encoded power signals have carrier frequencies different by more than 10% then assume that the encoded power signals are unique. If they are closer than 10%, then the text files must be compared by hand to see if they duplicate each other for the length of the shorter encoded power signal's text file—if they match for the duration of the shorter file, then eliminate the shorter.

### Creating a Compact Database of Encoded Power Signals

As stated earlier, the device of the present invention contains a database of encoded power signals. It is useful to have a database that contains as many encoded power signals as possible in order to power off as many types of television sets as possible. Since the number of encoded power signals that can fit into the database is limited by the size of storage available for the database in the device of the present invention (e.g., by the size of the ROM in the device of the present invention), and since smaller storage sizes are usually less expensive, it is advantageous to reduce the amount of storage needed by compacting the size of the encoded power signals in the database.

The acquisition of encoded power signals as described earlier provides text files with enough information to create a database of encoded power signals. All the device of the present invention needs to do is output to its IR LEDs a square-wave that it creates with varying high and low times that mimic the timing given in the text file for each encoded power signal. One simple way to do this would be to store all of the timing values in each text file into the database, and control a timer with this sequence of timing values (with a 250 millisec. delay between each encoded power signal). Although simple, this method would require a large database: if each text file contains an average of about 2000 timing values of 2 bytes each, and if the database contains about 100 encoded power signals, then the size of the database would be about 400 kilobytes.

There are many ways of compressing the data within the database of encoded power signals. Below is a description of one way that I accomplished the task. In the preferred embodiment, the database contains about 100 encoded power signals and uses up about 4 kilobytes of the microcontroller's ROM.

Most encoded power signals can be characterized to exploit the many patterns within them that can make it possible to store a relatively small amount of data for each encoded power signal and still be able to mimic the timing given in the text file for each encoded power signal. As it happens, the analysis of the data within the text files described earlier for eliminating duplicate encoded power signals can also be applied for characterizing encoded power signal data for compression purposes.

Theoretically, it would be possible to write software to automatically characterize all of the data given in the original text files and create data ready to be input into the database. As with the Decoding Software used for aiding in the elimination of duplicate encoded power signals, it would be a large project in itself to write such software, and I came up with a compromise that will still require some manual work on my part, but makes that job easier.

My compromise involved extending the Decoding Software described earlier. As described earlier, most encoded power signals consist of periods of time that a carrier frequency is on, and periods of time that there is no carrier signal (i.e., periods of time with no signal). Another way to look at this, which will be useful for implementing the device of the present invention, is that the encoded power signal consists of a carrier frequency that is gated on or off for various times. Encoded power signals that do not consist of a gated carrier are called an “exception” (these merely power the IR LED on and off for varying lengths of time, without a carrier). For each original text file that is not an “exception”, the Extended Decoding Software outputs a new text file. This new text file contains a number of On-Time/Off-Time pairs, one pair per line. An On-Time is defined as a length of time that the carrier frequency is present—during the On-Time, a square-wave at the carrier frequency is fed into the IR LEDs so that they blink on and off at the carrier frequency. An Off-Time is defined as a length of time that the carrier is not present—during the Off-Time, a digital Low is fed to the IR LEDs so that they are off. For the device of the present invention to output an encoded power signal, all it needs to do is output to the IR LEDs the sequence of On-Time/Off-Time pairs as listed in the new text file, using the On-Times to gate the carrier to the IR LEDs, and using the Off-Times to keep a digital Low at the IR LEDs. So, the database entry for each non-exception encoded power signal could consist of the carrier frequency's high period and low period, followed by a table of On-Time/Off-Time pairs from the new text file.

To make it easy to create each entry for the database, the Extended Decoding Software creates a new text file for each encoded power signal text file with all of the appropriate data: the carrier high period and low period followed by a listing of the On-Time/Off-Time pairs. To make it easier to create the database entry, the Extended Decoding software converts the carrier high period and low period expressed in nanosec. into times expressed in “counts”, and also converts the On-Times and Off-Times expressed in nanosec. into times expressed in “counts”. The timer in the microcontroller of the preferred embodiment that will generate the carrier (the “Carrier Timer”) is set up so that it decrements every 250 nanosec., so to convert carrier high period and low period into “counts”, divide the times (expressed in nanosec.) by 250. The timer that will gate the output of the carrier to the IR LEDs (the “Gating Timer”) is set up to decrement every 2000 nanosec., so to convert On-Times and Off-Times into “counts”, divide by 2000. This allows all carrier high and low times to fit into 1-byte quantities in the database and all On-Times and Off-Times to fit into 2-byte quantities in the database. For the encoded power signals that are “exceptions”, entries in the database will need to be generated entirely by hand from the original text file for the acquired encoded power signal: the device of the present invention needs to output the High times and Low times (no carrier) to the IR LEDs, and these values can also be expressed as counts of 2000 nanosec. (and fit into 2-byte quantities in the database).

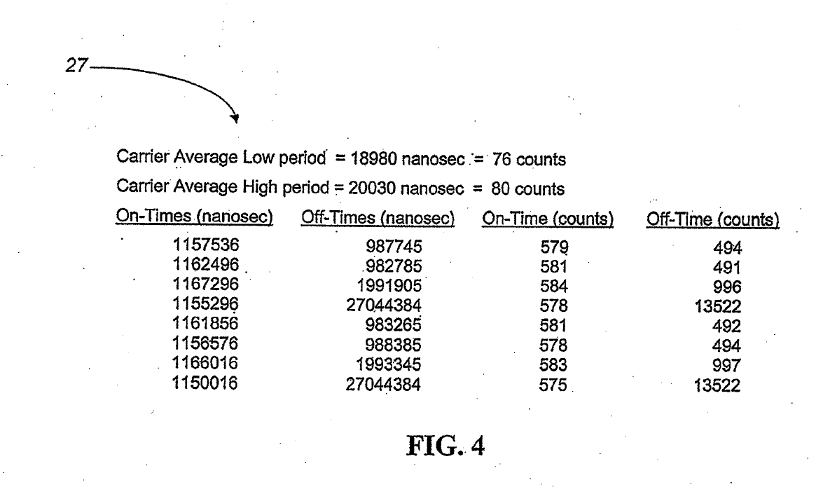

As an example, one acquired encoded power signal is represented by an original text file that has 480 2-byte values to describe the encoded power signal (these are timing values between all positive and negative edges of the digital signal), as output by the original Decoding Software. FIG. 4 shows the new text file output (27) from the Extended Decoding Software for this same encoded power signal. It contains the carrier average Low period, the carrier average High period, and a sequence of On-Time/Off-Time pairs. This is enough information to recreate and mimic the original encoded power signal: set up the Carrier Timer with the carrier high and low periods, and then gate the carrier using the Gating Timer by feeding Gating Timer with the sequence of On-Times and Off-Times. All the quantities are expressed both in nanosec. and in counts (only the values expressed in counts would be used in the database). The 8 pairs of On-Times and Off-Times expressed in counts could all be 2-byte quantities in the database. The carrier high time and low time are 1-byte quantities. So, this encoded power signal, characterized in this way, would take up 34 bytes in the database. This is a lot smaller than the original 480×2=960 bytes, but we can make it even smaller without much effort.

This data can be compressed using a standard compression technique. Notice that of the 8 On-Time/Off-Time pairs, there are only 3 unique pairs (plus or minus some small degree of measurement error): 581/494, 581/996 and 581/13522. These 3 On-Time/Off-Time pairs can be stored in a table of times (the “Time-Tab”) within the database, taking up 12 bytes. (The actual values for these times are chosen manually, choosing a value for each that either occur most frequently, or is in the middle of the range, e.g., 581 was chosen for all 3 On-Times since it occurs twice as an On-Time acquired for this code, and it is in the middle of the range of On-Times.) The first On-Time/Off-Time pair has an offset into the table of 0, the second pair has an offset into the table of 1, and the third pair has an offset into the table of 2. These offsets will fit into 4-bit quantities (a nybble), so that two nybble-sized offsets will fit into one byte. Therefore, we can represent the sequence of 8 On-Time/Off-Time pairs as the following sequence of 8 offsets into the table of times: 00120012. This sequence of 8 nybbles (the “Sequence of Nybbles”, each nybble of which is called a “Sequence Nybble”) takes up 4 bytes in the database. So, altogether, including the 2 bytes for the carrier high and low periods, this code would take up a total of 18 bytes in the database.

This encoded power signal can be further compressed if we make use of the fact that for this encoded power signal the On-Times are all the same (plus or minus some small degree of measurement error): 581. This On-Time can be stored separately in the database in 2 bytes. Then the table of times can contain only the 3 Off-Times, taking up 6 bytes of the database. The sequence of nybble offsets is the same 4 bytes, but now just points to Off-Times in Time-Tab, since we know what the On-Time always is. So, altogether, including the carrier High and Low periods, the On-Time, the Time-Tab, and the Sequence of Nybbles, this code would take up a total of 14 bytes in the database.

The example given above is for one form encoded power signal. They can take on other forms, too. I.e., there are many “Code-Types”. I had to come up with a way to characterize all encoded power signals in a general way to account for all Code-Types: From looking at all of the new text files output by the Decoding Software, I saw that I could categorize all of the encoded power signals according to 10 qualities that they may or may not have. 1) Some encoded power signals are “exceptions”, in that they have no carrier. 2) Some encoded power signals have a constant On-Time with Off-Times that vary. 3) Some have constant Off-Times with On-Times that vary. 4) For some codes, both the On-Times and the Off-Times vary. 5) Some only go through their sequence once (the “Main Sequence”), and others repeat their Main Sequence for as long as the TV remote control's POWER button is held down. 6) Some, when the POWER button is held down, play their Main Sequence once, then repeat a separate sequence for as long as the POWER button is held down—I call this sequence the “Hold-Down Sequence”. 7) Some have what I call a “Preamble” On-Time/Off-Time pair at the start of their Main Sequence. 8) Some have what I call a “Terminator” On-Time/Off-Time pair at the end of their Main Sequence. 9) Of those that repeat their Main Sequence while the POWER button is held down, some with Preambles repeat their Main Sequence without their Preamble (and these repeat 1 extra time more than those that repeat with their Preambles). 10) Of those that repeat their Main Sequence while the POWER button is held down, some with Terminators repeat their Main Sequence without their Terminator (and these repeat 1 extra time more than those that repeat with their Terminators). As I look at other encoded power codes in the future, there may be other qualities that I find can be added to the above list. At present, however, these 10 qualities suffice.

Characterization of the encoded power signals according to the above 10 qualities needs to be done by hand from the new text files (as output by the Extended Decoding Software), for the time being, since the amount of software necessary to do this automatically would have taken me much longer to write than characterizing the encoded power signals by hand.

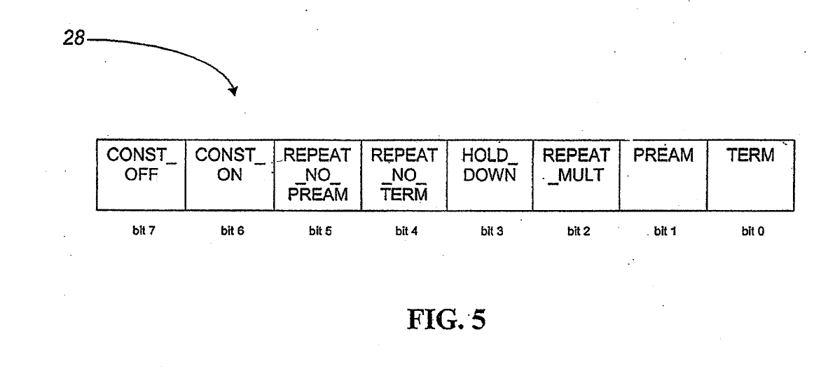

In order to account for all of these different qualities, and in order to have a consistent form for each database entry, it is worthwhile to precede each encoded power signal entry in the database with data about the code's qualities. FIG. 5 shows the 10 qualities of the encoded power signals, listed above, conveniently expressed in one 8-bit byte (28) called code_type. Bit 7 and bit 6 of code_type have 4 meaningful bit combinations. For an encoded power signal that is an exception (no carrier), both CONST_ON and CONST_OFF are set. The CONST_ON bit is set, with CONST_OFF bit clear, if the encoded power signal always has the same On-Time, with Off-Times that vary. The CONST_OFF bit is set, with CONST_ON bit clear, if the encoded power signal always has the same Off-Time, with On-Times that vary. If both the CONST_OFF bit and the CONST_ON bits are clear, then the On-Times and the Off-Times both vary for this code type. The REPEAT_MULT bit is clear if the Main Sequence of the code repeats only once no matter how long the POWER button is pressed down, and the REPEAT_MULT bit is set if the Main Sequence of the code repeats continually for as long as the POWER button is held. The HOLD_DOWN bit is set if the Main Sequence of the code repeats only once, and then repeats a Hold-Down sequence for as long as the POWER button is held down. The TERM bit is set if the encoded power code has a Terminator On-Time/Off-Time pair at the end of the Main Sequence. The PREAM bit is set if it has a Preamble On-Time/Off-Time pair at the beginning of the Main Sequence. The REPEAT_NO_TERM bit is set if the code's Main Sequence repeats without the Terminator. The REPEAT_NO_PREAM bit is set if the code's Main Sequence repeats without the Preamble.

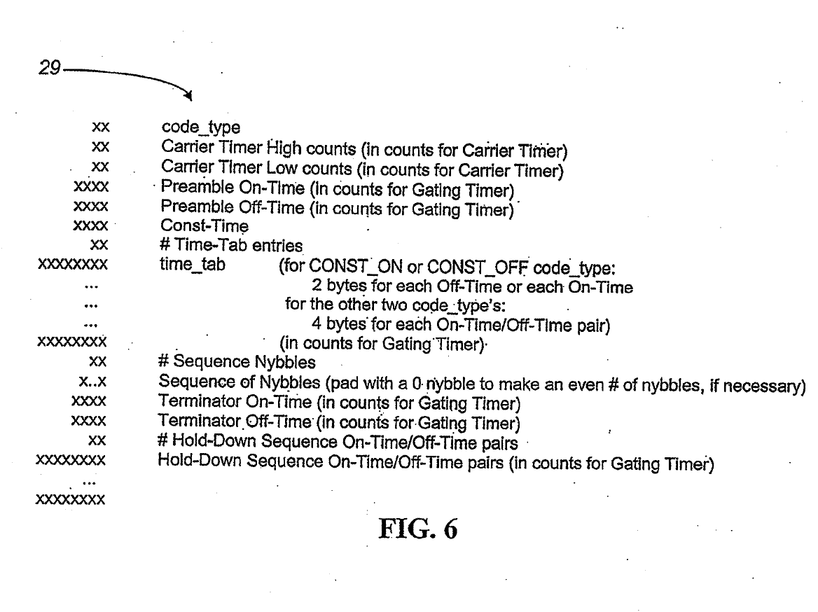

FIG. 6 shows the general form of each database entry for all encoded power signals (29). Not all code-types contain all sections. The first byte is always the code_type byte. What follows depends on the code_type byte. The next 2 bytes are the carrier High period and Low period, which exist for all code-types but exception types (i.e., for all code-types for which bit 7 and bit 6 (CONST_ON and CONST_OFF) of code_type aren't both set). The Preamble On-Time/Off-Time pair only exists if bit 1 (PREAM) of code_type is set. Const-Time exists when bit 7 (CONST_OFF) or bit 6 (CONST_ON) of code_type are set, but not both. # Time-Tab entries exists for all Code-Types. The table of times, time_tab, also exists for all Code-Types, but the type of times is different depending on code_type: for code_type with bit 7 (CONST_OFF) set and bit 6 (CONST_ON) clear, time_tab contains 2 bytes for each constant On-Time; for code_type with bit 7 (CONST_OFF) clear and bit 6 (CONST_ON) set, time_tab contains 2 bytes for each constant Off-Time; for code_type with bit 7 (CONST_OFF) clear and bit 6 (CONST_ON) clear, time_tab contains 4 bytes for each On-Time/Off-Time pair; and for code_type with bit 7 (CONST_OFF) set and bit 6 (CONST_ON) set, time_tab contains 4 bytes for each High-Time/Low-Time pair (no carrier for “exception” Code-Type). All Code-Types use the # Sequence Nybbles and the Sequence of Nybbles. The Sequence of Nybbles must use an integer number of bytes, so if # Sequence Nybbles is odd, then a 0 nybble is added to the end of the Sequence of Nybbles. The Terminator On-Time/Off-Time pair only exists if bit 0 (TERM) of code_type is set. # Hold-Down On-Time/Off-Time pairs and the Hold-Down Sequence exist only if bit 3 (HOLD_DOWN) is set.

The way that the database is currently structured, the Hold-Down Sequence is always a series of On-Time/Off-Time pairs. Some bytes could have been saved if the Hold-Down sequence were broken down into its own Tithe-Tab and Sequence of Nybbles, as with the Main Sequence, but since Hold-Down Sequences are fairly short for most encoded power signals that have one, the space-saving isn't very great compared to the amount of extra firmware required to implement it.

Bit 2 (REPEAT_MULT) of code_type does not change what exists in the database entry—it does determine, however, how many times the Main Sequence is repeated during transmission of the encoded power signal. If it is clear, the Main Sequence repeats once; if it is set, the Main Sequence repeats 4 times. The number of repetitions is called REPEAT_COUNTS. REPEAT_COUNTS=4 is an arbitrary number of times. Since there is no POWER button to hold down on the device of the present invention, I chose to repeat the sequences 4 times. This is long enough to better ensure that a television will “see” the encoded power signal, and it is short enough so that it won't take too long to transmit. The number is increased by 1 (to 5) if bit 5 (REPEAT_NO_PREAM) or bit 4 (REPEAT_NO_TERM) of code_type are set.

Bit 5 (REPEAT_NO_PREAM) and bit 4 (REPEAT_NO_TERM) of code_type do not change what exists in the database entry—whether they are set or not does determine, however, whether the Preamble or Terminator are transmitted if the Main Sequence is repeated multiple times (which is the case when bit 2 (REPEAT_MULT) is set).

With the general form of each database entry shown in FIG. 6 the database can consist of any number of entries, one immediately following the other in storage of the device of the present invention (such as the ROM of a microcontroller).

Some examples will show more clearly the structure of database entries, as well as how the encoded power signals are transmitted by the device of the present invention from its database entry. All values in these examples are shown in hexadecimal unless Otherwise stated.

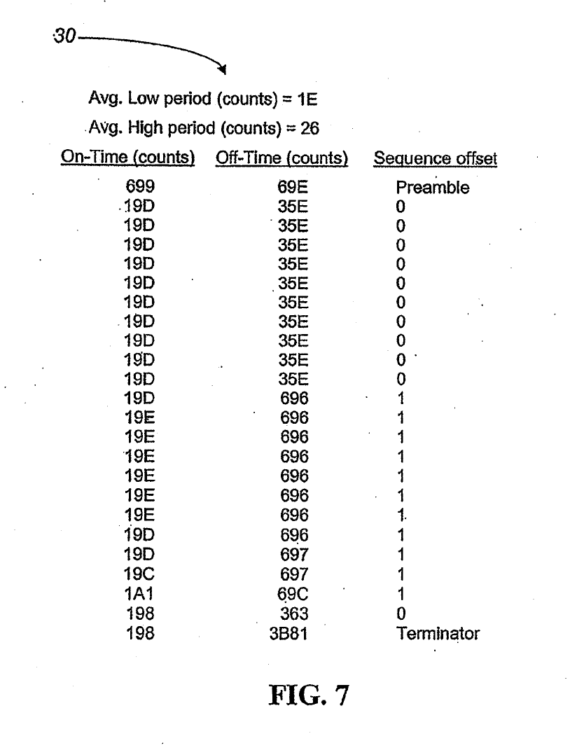

The first two columns of FIG. 7 show the first several lines of output (30) of the Extended Decoding Software for an encoded power signal where code_type=57. The 3^{rd} column was added by hand, showing the sequence. This is the Main Sequence for the encoded power signal. The lines that followed those shown in FIG. 7 repeat the Main Sequence, except without the last On-Time/Off-Time pair. So, we can call the last On-Time/Off-Time pair the Terminator. This encoded power signal was characterized as 57 because, except for the first On-Time/Off-Time pair, all lines have the same On-Time (plus or minus some small degree of measurement error): 19E. If we call this first On-Time/Off-Time pair the Preamble, then we can store the rest of the pairs as simply Off-Times, with the On-time stored just once. Aside from the Terminator, there are only 2 unique Off-Times (plus or minus some small degree of measurement error): 35E and 696. From this, we determine that the code_type consists of the following bits set: CONST_ON, REPEAT_NO_TERM, REPEAT_MULT, PREAM, TERM=57. Table 3 shows the database entry for this encoded power signal. Column 1 shows the hexadecimal values that are the database entry for this encoded power signal. Column 2 is just shown for explanatory purposes.

TABLE 3

| Column 1 | Col. 2 |
|---|---|
| 57 | code_type = 57 |
| 26 | Carrier Timer High counts |
| 1E | Carrier Timer Low counts |
| 0699 | Preamble On-Time |
| 069E | Preamble Off-Time |
| 019E | On-Time |
| 02 | # Time-Tab entries |
| 035E | table of Off-Times: 2 bytes per Off-Time |
| 0696 | |
| 16 | # Sequence Nybbles |
| 00 00 00 00 00 11 11 11 11 11 10 | Sequence of Nybbles |
| 019E | Terminator On-Time |
| 3B81 | Terminator Off-Time |

To transmit this code from the database, the device of the present invention firmware gets the code_type byte and sees that the next two bytes are the carrier High and Low periods, which it uses to set up the Carrier Timer. Then the Preamble is transmitted by setting up the Gating Timer with the Preamble On-Time and then the Preamble Off-Time (to gate the carrier On and then Off, respectively). Then each Main Sequence On-Time/Off-Time pair is sent out by alternately setting up the Gating Timer with the On-Time (to gate the carrier On) and then the next Off-Time pointed to by the next Sequence Nybble (to gate the carrier Off). When the Sequence of 22 (decimal) On-Time/Off-Time pairs is complete, then the Terminator is transmitted by setting up the Gating Timer with the Terminator On-Time and then the Terminator Off-Time (to gate the carrier On and then Off, respectively). Then repeat the Sequence of 22 (decimal) On-Time/Off-Time pairs 4 more times (REPEAT_COUNTS), preceded by the Preamble each time (but without the Terminator).

With this 30-byte entry in the database, the device of the present invention can mimic the encoded power signal, and so, turn off any television set that responds to this encoded power signal.

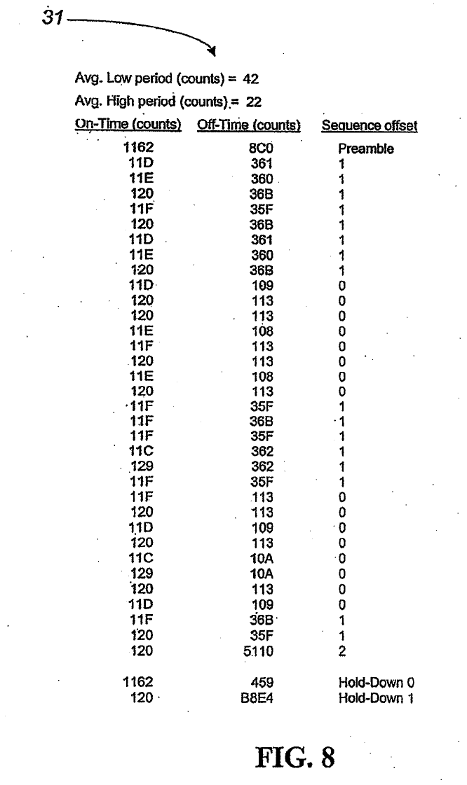

As another example, the first two columns of FIG. 8 show the first several lines of output (31) of the Extended Decoding Software for an encoded power signal where code_type=4A. The 3^{rd} column was added by hand, showing the sequence. This Code-Type is similar to the previous example (code_type 57), except that this Code-Type has only a Preamble (no Terminator), and after the Main Sequence completes, a Hold-Down sequence is repeated 4 times (REPEAT_COUNTS).

It so happens that all lines that follow those shown in FIG. 8 repeat the last two lines for as long as the remote control's POWER button was pressed—these last two lines are the Hold-Down sequence. Notice that, for the Main Sequence, all of the On-Time/Off-Time pairs have the same On-Time (plus or minus a small percentage of measurement error) except for the first pair. If we call this first pair the Preamble, then we can store the rest of the pairs as simply Off-Times, with the On-time stored just once. The Hold-Down Sequence will also be stored separately.

This encoded power signal was characterized as 4A because, except for the first On-Time/Off-Time pair, all lines have the same On-Time (plus or minus some small degree of measurement error): 120. And, except for the Hold-Down Sequence, there are only 3 unique Off-Times (plus or minus some small degree of measurement error): 113, 362, and 5110. So, the code_type consists of the following bits set: CONST_ON, HOLD_DOWN, PREAM=4A. Table 4 shows the database entry for this encoded power signal. Column 1 shows the hexadecimal values that are the database entry for this encoded power signal. Column 2 is just shown for explanatory purposes.

TABLE 4

| Column 1 | Col. 2 |
|---|---|
| 4A | code_type = 4A |
| 22 | Carrier Timer High counts |
| 42 | Carrier Timer Low counts |
| 1162 | Preamble On-Time |
| 08C0 | Preamble Off-Time |
| 0120 | On-Time |
| 03 | # Time-Tab entries |
| 0113 | table of Off-Times: 2 bytes |
| | per Off-Time |
| 0362 | |
| 5110 | |
| 21 | # Sequence Nybbles |
| 11 11 11 11 00 00 00 00 11 11 11 | Sequence of Nybbles |
| | (last byte padded with 0) |
| 00 00 00 00 11 20 | |
| 02 | # Hold-Down Seq. On-Time/ |
| | Off-Time pairs |
| 1162 0459 | 4 bytes for each Hold-Down |
| | Sequence pair |
| 0120 B8E4 | |

Since there is an odd # Sequence. Nybbles the Sequence of Nybbles would not end on a byte-boundary, so a 0 nybble is added to the end of the Sequence of Nybbles to fix that.

To transmit this code from the database, the device of the present invention firmware gets the code_type byte and sees that the next two bytes are the carrier High and Low periods, which it uses to set up the Carrier Timer. Then the Preamble is transmitted by setting up the Gating Timer with the Preamble On-Time and then the Preamble Off-Time (to gate the carrier On and then Off, respectively). Then each Main Sequence On-Time/Off-Time pair is sent out by alternately setting up the Gating Timer with the On-Time (to gate the carrier On) and then the next Off-Time pointed to by the next Sequence Nybble (to gate the carrier Off). When the Sequence of 33 (decimal) On-Time/Off-Time pairs is complete, then the Hold-Down Sequence is sent. The Hold-Down Sequence is a sequence of 2 On-Time/Off-Time pairs, given in the order they should be transmitted (via the Gating Timer). When the Hold-Down Sequence is complete, repeat the Hold-Down sequence 3 more times (4 times total: REPEAT_COUNTS).

With this 43-byte entry in the database, the device of the present invention can mimic the encoded power signal, and so, turn off any television set that responds to this encoded power signal.

As a final example, we'll look at an exception Code-Type. This Code-Type has no carrier. These Code-Types must be characterized completely by hand, since the Extended Decoding Software does not deal with them.

Table 5 shows the first 14 lines of output of the old text file for an acquired encoded power signal that has no carrier. The Column 1 shows the High-Periods in nanosec., and Column 2 shows the Low-Periods in nanosec.

TABLE 5

| Column 1 | Col. 2 |
|---|---|
| High-Period (nanosec.) | Low-Period (nanosec.) |
| 23040 | 298880 |
| 23040 | 99040 |
| 22880 | 99040 |
| 23040 | 199040 |
| 23040 | 199040 |
| 23040 | 198880 |
| 23040 | 99040 |
| 23040 | 199040 |
| 23040 | 98880 |
| 23040 | 199040 |
| 23040 | 198880 |
| 23040 | 99040 |
| 23040 | 299040 |
| 23040 | 127817920 |

These 14 lines of data represent a square-wave with the given High periods and Low periods. It so happens that all lines that follow in the text file repeat these same 14 lines (plus or minus some small amount of measurement error) for as long as the remote control's POWER button was pressed. In order to reproduce this square-wave, first of all, we need to convert the time in nanosec. to counts. This is done by dividing each time by 2000 nanosec./count. The results are shown in Column 1 and Column 2 of Table 6.

TABLE 6

| Column 1 | | Col. 2 | | Col. 3 |
|---|---|---|---|---|
| High period (counts) | | Low period (counts) | | Sequence offset |
| 12 | (000C hex) | 150 | (0096 hex) | 0 |
| 12 | (000C hex) | 50 | (0032 hex) | 1 |
| 11 | (000B hex) | 50 | (0032 hex) | 1 |
| 12 | (000C hex) | 100 | (0064 hex) | 2 |
| 12 | (000C hex) | 100 | (0064 hex) | 2 |
| 12 | (000C hex) | 99 | (0063 hex) | 2 |
| 12 | (000C hex) | 50 | (0032 hex) | 1 |
| 12 | (000C hex) | 100 | (0064 hex) | 2 |
| 12 | (000C hex) | 50 | (0032 hex) | 1 |
| 12 | (000C hex) | 100 | (0064 hex) | 2 |
| 12 | (000C hex) | 100 | (0064 hex) | 2 |
| 12 | (000C hex) | 50 | (0032 hex) | 1 |
| 12 | (000C hex) | 150 | (0096 hex) | 0 |
| 12 | (000C hex) | 63909 | (F9A5 hex) | 3 |

We can see that (plus or minus some small amount of measurement error) all of the High-Periods are the same: 000C. Also (plus or minus some small amount of measurement error), there are 4 different Low-Periods. Since there is no carrier, however, we don't have the ability within out characterization scheme to make use of the constant High-Period, so we will characterize this code as having 4 unique High-Period/Low-Period pairs: 0000C/0096, 000C/0032, 000C/0064, 000C/F9A5. With Sequence offsets of 0, 1, 2, 3, respectively, these are shown in Column 3 of Table 6.

We now have enough information to create the database entry for this encoded power signal. Table 7 shows the results. Column 1 shows the hexadecimal values that are the database entry for this encoded power signal. Column 2 is just shown for explanatory purposes.

TABLE 7

| Column 1 | Col. 2 |
|---|---|
| C4 | Type C4 |
| 04 | # Time-Tab entries |
| 000C 0096 | High-Time/Low-Time pairs: 4 bytes/pair |
| 000C 0032 | |
| 000C 0064 | |
| 000C F9A5 | |
| 0E | # Sequence Nybbles |
| 01 12 22 12 12 21 03 | Sequence of Nybbles |

To transmit this code from the database, the device of the present invention firmware gets the code_type byte and sees that there is no carrier, so the next byte in the database contains the number of Time-Tab entries. Each Main Sequence High-Period/Low-Period pair is sent out by setting up the Gating Timer with the High-Period (which lights up the IR LEDs) and then the Low-Period (which powers off the IR LEDs) from the High-Period/Low-Period pair pointed to by the next Sequence Nybble. When all 14 pairs from the table have been transmitted, then all 14 pairs are transmitted again 3 more times (4 times total: REPEAT_COUNTS).

With this 26-byte entry in the database, the device of the present invention can mimic the encoded power signal, and so, turn off any television set that responds to this encoded power signal.

Given the above information and examples, those skilled in the art can see how to create a compact database, ready to be used in the device of the present invention.

### Theory of Hardware Operation

FIG. 1 is a depiction of an embodiment of the device of the present invention using a smiley-face pin. This has 2 IR LEDs (1) for the “eyes”, a push-button switch (2) for the “nose”, on a 3″ diameter smiley-face pin (3).

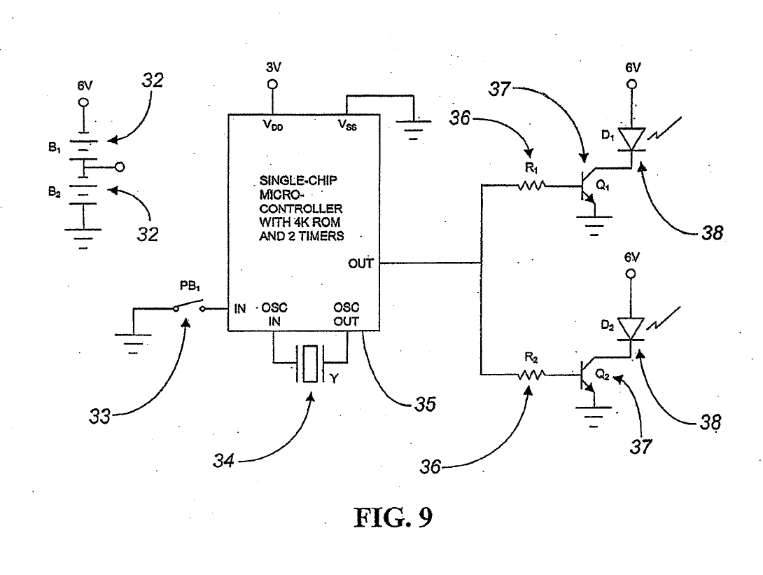

FIG. 9 shows a schematic diagram of the preferred embodiment of the device of the present invention. The microcontroller (35) was chosen because it is inexpensive and was specifically designed to easily implement an IR remote control; it contains two built-in timers, has a very low current draw from the batteries when it is in “sleep” mode (it draws about 10 microamps while in sleep mode), and has a built in ROM of sufficient size to store the controlling firmware and the database of encoded power signals (4 KB of ROM is sufficient). The two IR LEDs (38) output 980 nm IR light, one with 25 degree radiation angle, the other with 15 degrees (these are the “eyes” in FIG. 1). A ceramic resonator (34) is used instead of a crystal since it is accurate enough, and it is more inexpensive than a crystal or an oscillator. The push-button switch (33) is an inexpensive carbonized rubber switch with contacts as traces on the printed circuit board (this is the “nose” in FIG. 1). The 2 coin-cell batteries (32) are in series so that the microcontroller is powered by 3 v, and the LEDs are powered by 6 v. The driver transistors (37) with their base resistors (36) Pare optional, but they allow for brighter output from the IR LEDs (38).

The hardware of the device of the present invention is very simple because almost everything is done inside of the microcontroller. The microcontroller contains two timers that are designed to make generation of IR codes easy. One timer is an 8-bit timer. I use this as the Carrier Timer. The other timer is a 16-bit timer, which I use as the Gating Timer. Each timer has an output that toggles each time the timer times out. Each timers' output goes to a two-input AND gate that is inside of the microcontroller. The output of the AND gate goes to an output pin of the microcontroller. From there, the signal is sent to the non-inverting transistor drivers (36) that drive the IR LEDs (38).

Before the transmission of an encoded power signal begins, both timers are disabled, and both outputs (which are inputs to the internal AND gate) are Low. To start the transmission, first the Carrier Timer is set up. If the Code-Type is an exception (no carrier), the Carrier Timer is set up to output a constant High, otherwise the Carrier Timer is set up to generate a square wave with the appropriate High period and Low period to generate the carrier, which is present at one of the two inputs of the microcontroller's AND gate. The Gating Timer is then set up to gate the carrier On and Off with the appropriate periods for the given encoded power signal, as determined by the encoded power signal's entry in the database (for exception Code-Types the Gating Timer is functionally connected to the microcontroller's output since the Carrier Timer output is a constant High).

Let's take a closer look at how the timers function. The Carrier Timer is set up as a Mod-N counter that decrements one count per 250 nanosec. The output of the Carrier Timer is initially Low for generating encoded power signals with a carrier, otherwise the output is set to High and remains High. Each time the Carrier Timer counts down to 0 (a “time out”), it's output toggles, and it loads the contents of one of its hold registers, and starts counting down immediately. If the output is High when the timer times out, then it reloads with the value in the Low hold register; if the output is Low when the timer times out, then it reloads with the value in the High hold register. So, to generate a carrier frequency with proper High and Low periods, the carrier's High period is loaded into the High hold register, and the carrier's Low period is loaded into the Low hold register.

The Gating Timer is set up as a Mod-N counter that decrements one count per 2000 nanosec. The output of the Gating Timer is initially Low. Each time the Gating Timer times out, it's output toggles, and it loads the contents of its 16-bit hold register, and starts counting down immediately. When the Gating Timer is first started it's output goes High, thus allowing the Carrier Timer to output through to the internal AND gate's output (which then goes to the microcontroller's output, where it controls the IR LEDs). So, if the Carrier Timer is generating a carrier (which is the case for all but exception Code-Types), the device of the present invention is generating an On-Time (otherwise the IR LEDs are just powered on, since the Carrier Timer output is just a static High). While the Gating Timer is decrementing the first On-Time, the 16-bit hold register is loaded with the Off-Time. When the On-Time times out, the Gating Timer's output toggles to Low, thus gating the AND gate's output to Low, thus turning power off to the IR LEDs, and the Off-Time in the hold register gets loaded into the Gating Timer, and it starts decrementing immediately. While the Gating Timer is decrementing the Off-Time, the next On-Time is loaded into hold register. This process continues until the entire encoded power signal is generated, at which point both timers are disabled, bringing both of their outputs Low, and thus turning off the IR LEDs.

### Theory of Firmware Operation

In the preferred embodiment, the database of encoded power signals is stored in the microcontroller's ROM in an efficient way (as described earlier). Also stored in the microcontroller's ROM is the firmware that controls the device of the present invention.

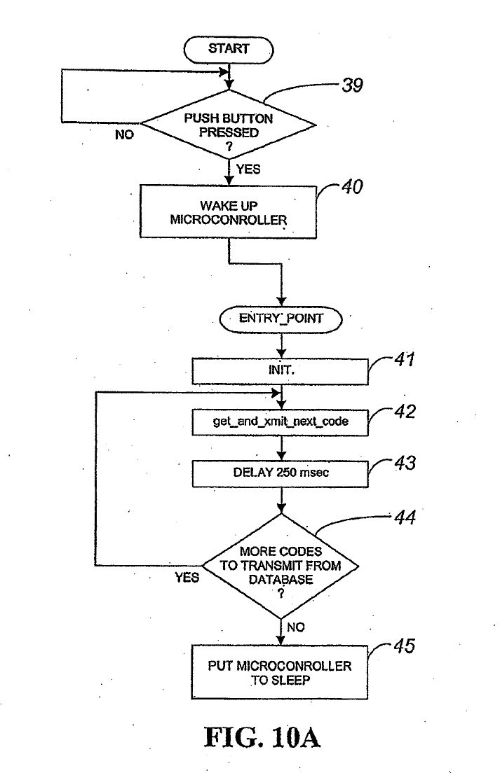

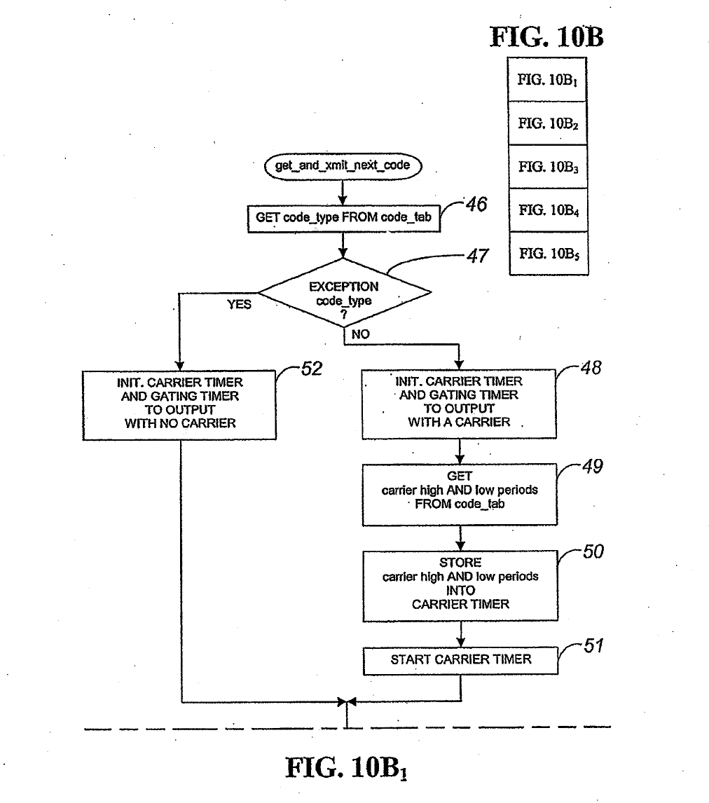

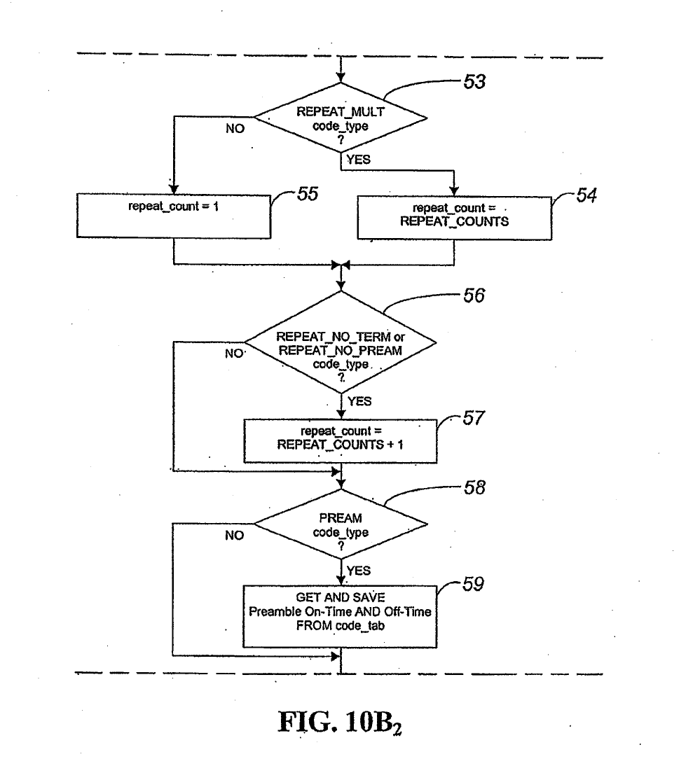

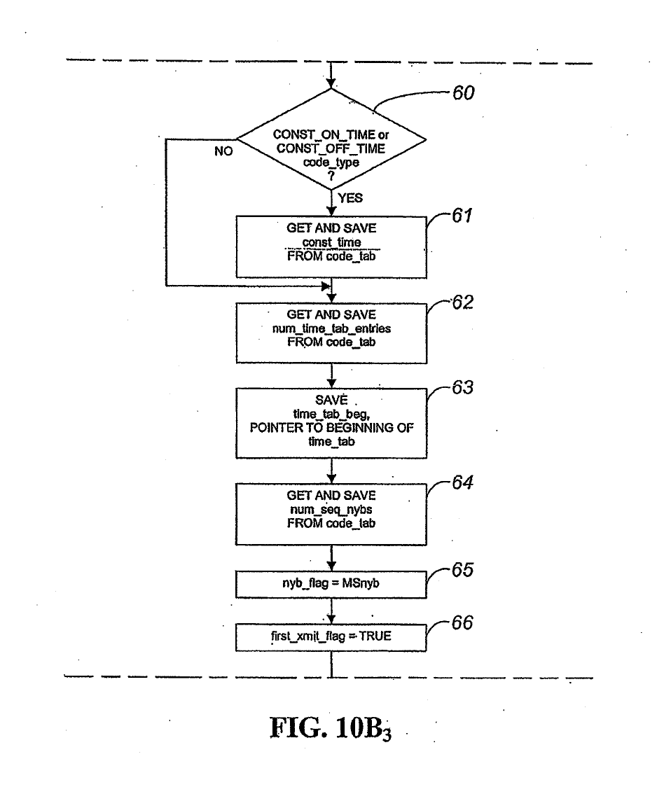

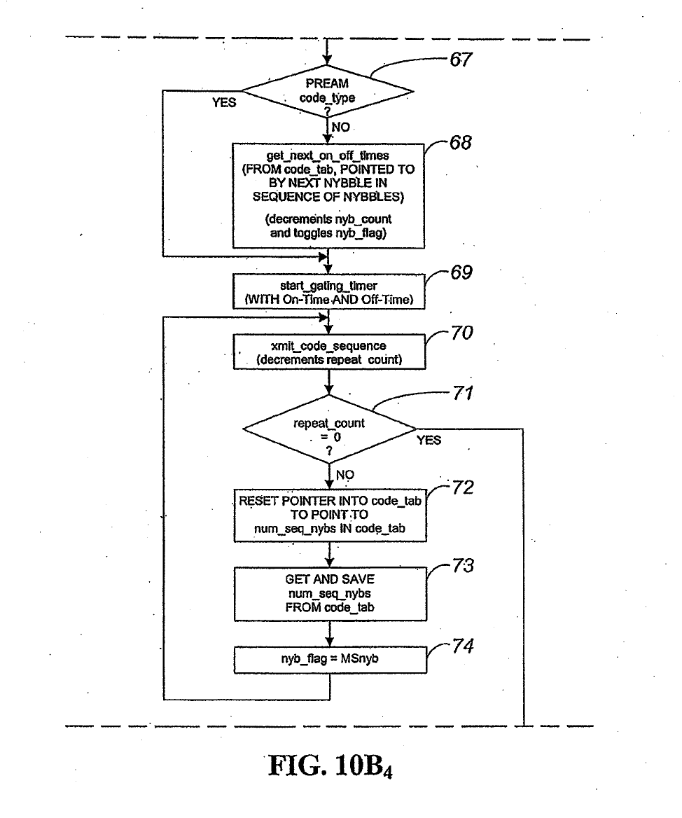

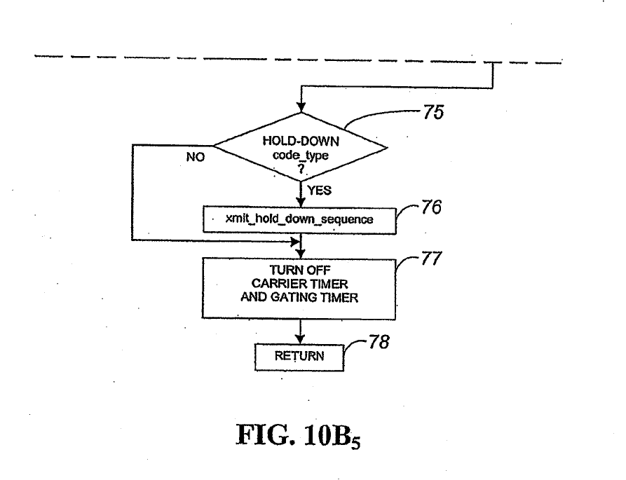

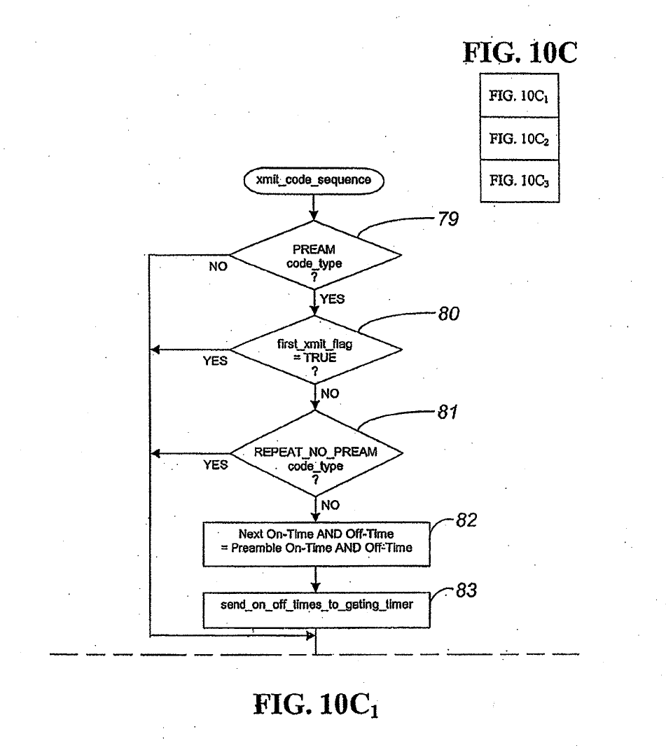

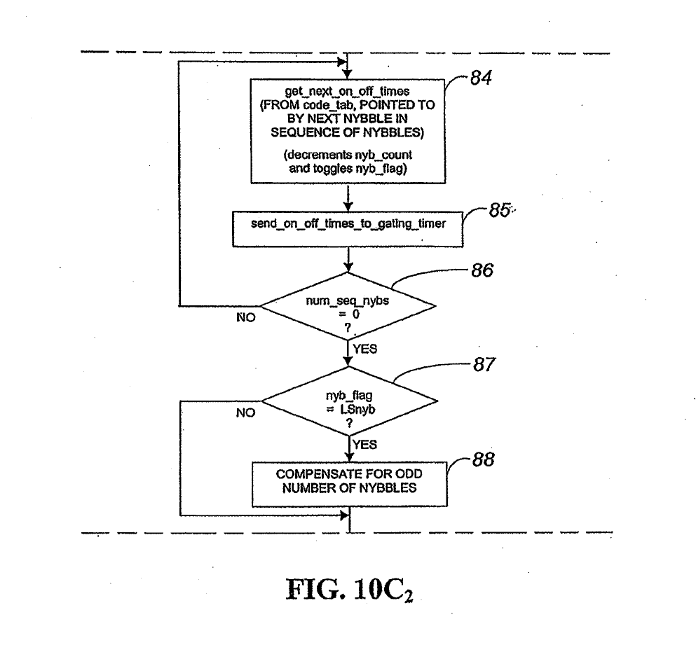

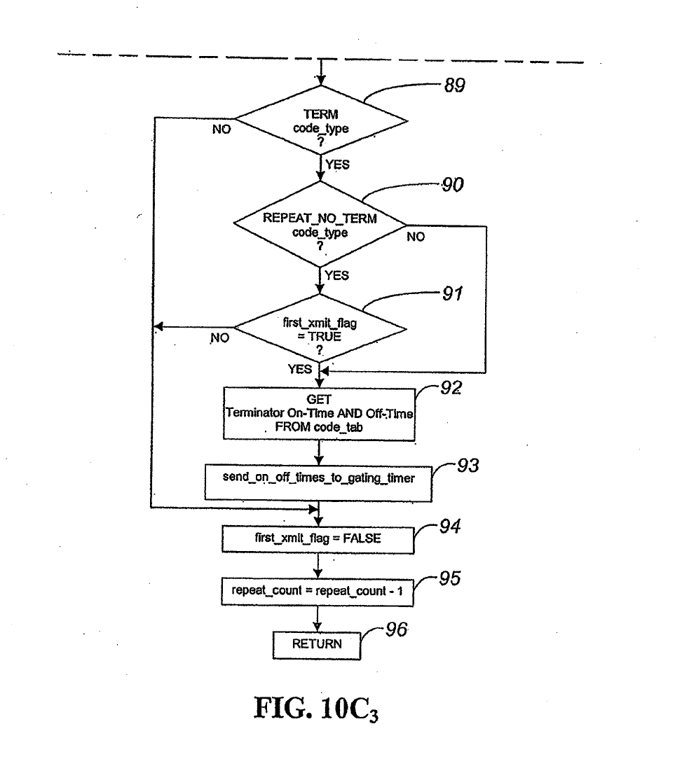

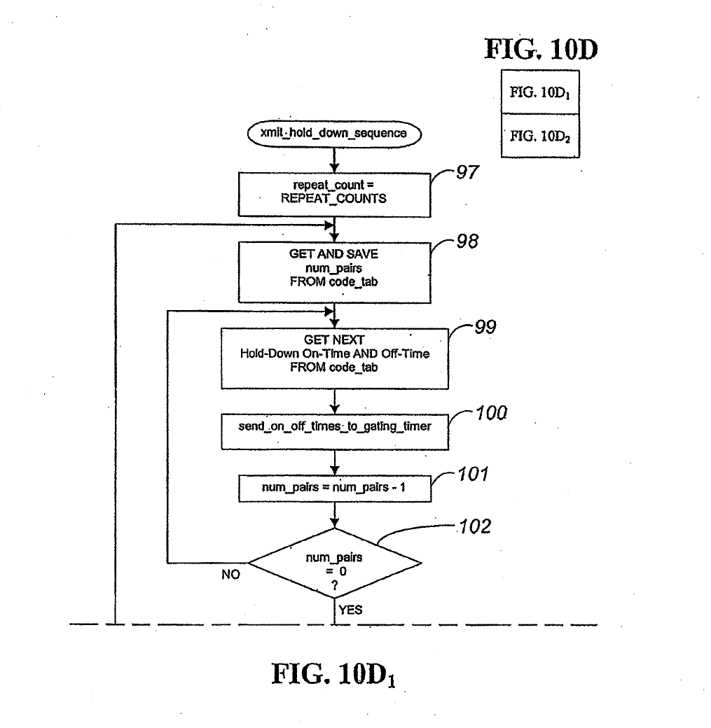

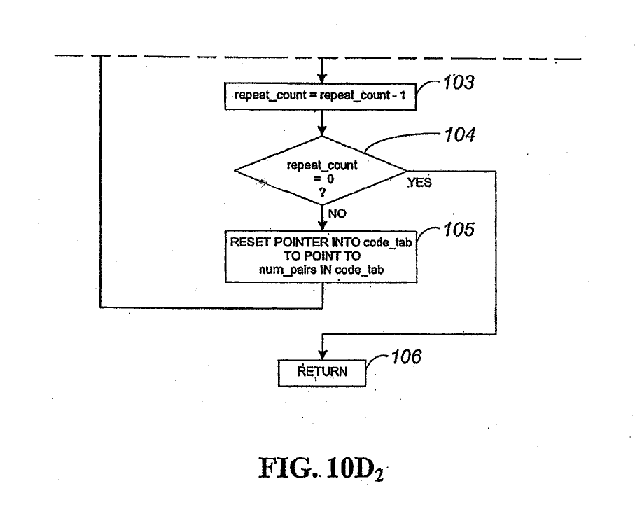

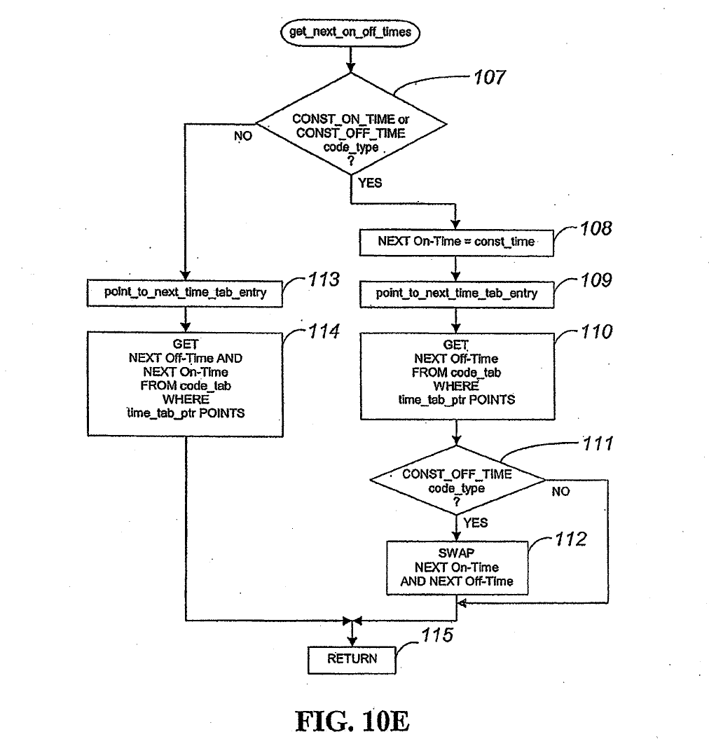

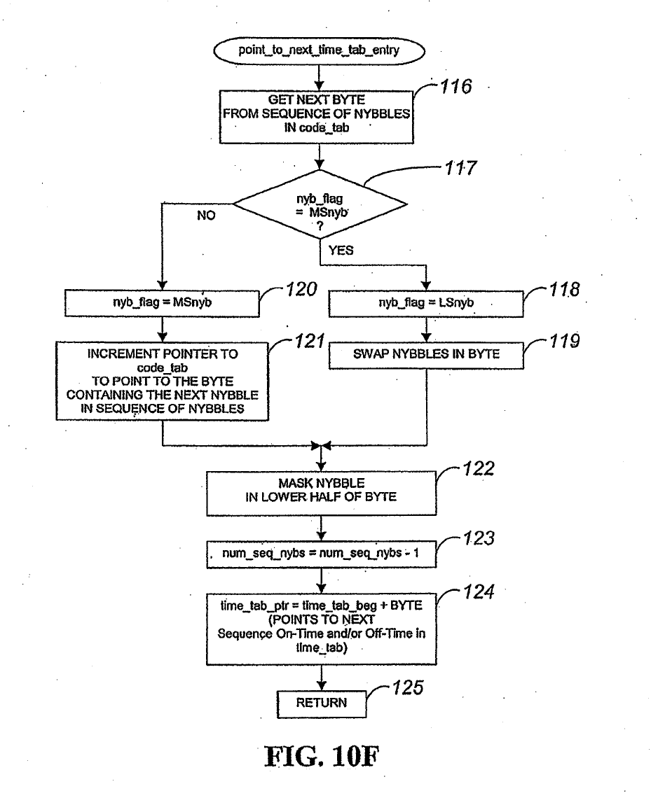

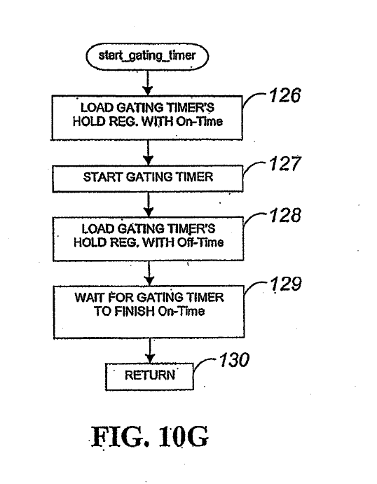

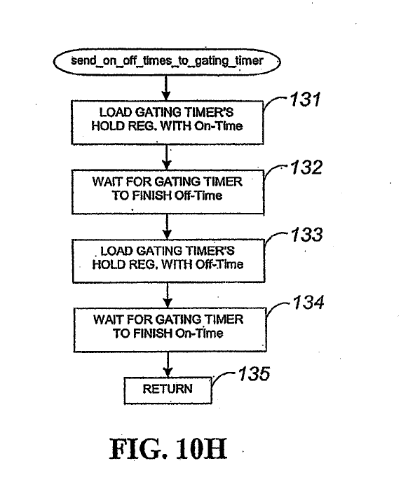

FIG. 10A shows a flow chart of the main routine of the firmware. While in sleep mode, the microcontroller is waiting for the push-button switch to be pushed (39). When it is pushed, the microcontroller wakes up (40), and it starts executing the firmware, starting at the beginning with initialization (41). Initialization includes initializing all of the microcontroller's registers and setting up the two timers to function as the Carrier Timer and the Gating Timer; it also initializes code_tab_ptr to point to the beginning of code_tab, the database of encoded power signals. Then it sequences through the entire database of encoded power signals, sending each encoded power signal out (42) one after the other, with a 250 millisec. gap between each (43). After it has transmitted the last encoded power signal from the database, it then turns off the device of the present invention by putting back it into sleep mode (45).

FIG. 10B shows a more detailed flow chart of how the firmware constructs and transmits one encoded power signal. This is the get_and_xmit_next_code subroutine. This subroutine and the ones that follow make use of the general structure of each entry in the database of encoded power signals, as described earlier for FIG. 6; the general structure was designed to make the flow of the firmware as easy as possible. After transmitting the encoded power signal pointed to by code_tab_ptr, this subroutine returns with code_tab_ptr pointing to the next encoded power signal in code_tab.

The get_and_xmit_next_code subroutine is called with code_tab_ptr pointing to the first byte of the encoded power signal in code_tab that it is about to transmit. This first byte is code_type (46). This byte contains the qualities necessary to know about the encoded power signal that is about to be transmitted. It also determines how the following bytes are interpreted for this code's entry in the database. If the code_type indicates an exception (47), then the Carrier Timer is initialized to output a static High (52), otherwise, the Carrier Timer is initialized to output a carrier (48), the next 2 bytes are retrieved from code_tab (49) and stored into the Carrier Timers High and Low hold registers (50), and the Carrier Timer is started (51). The output of the Carrier Timer only goes as far as the microcontroller's internal AND gate until the Gating Timer's output goes High.

Next the firmware determines how many times to repeat the Main Sequence. If the REPEAT_MULT bit of code_type is not set (53), then repeat_count=1 (55), so that the Main Sequence will repeat only once. If REPEAT_MULT is set, then repeat_count=REPEAT_COUNTS (54), so that the Main Sequence will repeat 4 times (an somewhat arbitrary number, as described earlier). If code_type has REPEAT_NO_TERM or REPEAT_NO_PREAM set (56), then repeat_count needs to be incremented (57).

If the code_type has a Preamble (58), then the next 4 bytes are gotten from code_tab (59), which are the Preamble On-Time and Off-Time. They are saved for later use. They are also stored as next_on_time and next_off_time, as these will be the first values transmitted. If the code_type has a constant On-Time or a constant Off-Time (60), then the next byte is gotten from code_tab (61), which is the constant time (either a constant On-Time or a constant Off-Time). It is saved for later use. The next byte is the number of time_tab entries. It is gotten and saved for later use (62). Now code_tab_ptr is pointing to the beginning of the time_tab. This value is saved for later use (63). The number of Sequence Nybbles is the byte after the time_tab. It is gotten from code_tab and saved as nyb_count (64).

Next, nyb_flag is set to MSnyb (65). The nyb_flag is used to keep track of where the next nybble is in the Sequence of Nybbles—when transmitting the Main Sequence, we'll want to retrieve one nybble offset at a time from the Sequence of Nybbles, but the microcontroller works with 8-bit bytes, so we'll read a byte at a time and mask off the nybble we are interested in at the moment.

Next, first_xmit_flag=TRUE (66), to indicate that we are about to transmit the Main Sequence for the first time—(since some code_types don't repeat the Preamble or the Terminator after the first repeat, we need to keep track of this).

If this code_type does not have a Preamble (67), then we still need to get the first On-Time and Off-Time from code_tab (68). These are retrieved by the get_next_on_off_times subroutine. This subroutine performs the function of getting the next On-Time and Off-Time according to where the next nybble offset (from the Sequence of Nybbles) is pointing within time_tab. It returns with next_on_time and next_off_time equal to the retrieved times. It also returns with code_tab_ptr pointing to the byte where the next nybble-offset resides (from the Sequence of Nybbles), with nyb_flag indicating whether the pertinent nybble is in the MS or LS nybble, and with nyb_count decremented by one (since we have one less nybble-offset to go). The get_next_on_off_times subroutine will be described in detail later.

Now the first On-Time and Off-Time (stored as next_on_time and next_off_time) are sent to the Gating Timer and the Gating Timer is started (69) with the start_gating_timer subroutine. The start_gating_timer subroutine will be described in detail later. Once the Gating Timer is started, the a LEDs start lighting up, and the transmission of the encoded power signal has begun.

With the timers going, we are now ready to send the rest of the Main Sequence, and repeat the Main Sequence the correct number of times (according to repeat_count). The xmit_code_sequence subroutine sends the Main Sequence once (70), and returns with code_tab_ptr pointing to the byte after the Sequence of Nybbles in code_tab. It also returns with repeat_count decremented. The xmit_code_sequence subroutine will be described in detail later. After returning from xmit_code_sequence, if repeat_count is not 0 (71), then reset some variables so we can repeat the transmission of the Main Sequence with xmit_code_sequence. These are the variables that need to be reset: reset code_tab_ptr to again point to num_seq_nybs (72), grab and save num_seg_nybs as nyb_count (73), and reset nyb_flag=MSnyb (74).

If there is a Hold-Down Sequence (75), then it need to be transmitted, which is done by xmit_hold_down_sequence (76). The xmit_hold_down_sequence will be described in detail later. If there is no Hold-Down Sequence, or if we've just finished transmitting the Hold-Down Sequence, then we're done transmitting this encoded power signal, so turn off both timers (77), which brings their output Low, thus turning off the IR LEDs, and return from this subroutine (78).

FIG. 10C shows the details of the xmit_code_sequence subroutine. This subroutine transmits the Main Sequence once. It does it differently depending on the qualities of the code_type and depending on whether this is the first time the Main Sequence is being transmitted. If it is the first time being transmitted, then first_xmit_flag=TRUE to indicate this (otherwise it is FALSE). If it is the first time, then we reach this subroutine with either the Preamble (if the code_type has one) already started in the Gating Timer, or with the first of the On-Time/Off-Time pairs from the Sequence already started in the Gating Timer (if the code_type does not have a Preamble). So, the first thing the subroutine does, is check to see if the code_type has a Preamble (79). If it doesn't, then no need to send one. If it does, then if it is the first repetition of the Main Sequence (i.e., if first_xmit_flag=TRUE) (80), then no need to send the Preamble, since it's already being sent. If it's not the first repetition, (first_xmit_flag=FALSE), then we check to see if this code_type has the quality that has it repeat the Main Sequence without sending the Preamble (81). If so, then don't send it. Otherwise, set next_on_time and next_off_time to the saved Preamble values (82) and send the values to the Gating Timer with the send_on_off_times_to_gating_timer subroutine (83). The send_on_off_times_to_gating_timer subroutine will be described in detail later.

Next, we send all of the times according to the Sequence of Nybbles. The work of retrieving the correct values into next_on_time and next_off_time is done by get_next_on_off_times (84) (which we saw mentioned earlier, and the details of which will be described later). After retrieving the correct values we send them to the Gating Timer with send_on_off_times_to_gating_timer (85). We keep getting and sending On-Time/Off-Time pairs until there are no more Sequence Nybbles (86). When there are no more Sequence Nybbles, if there were an odd number of them, we are pointing to the LS nybble of the last byte in the Sequence of Nybbles (which is a 0 pad byte). So, if nyb_flag=LSnyb (87), then increment code_tab_ptr to point past this last byte in the Sequence of Nybbles (88).

Now, we see if the code_type has a terminator (89). If not, then no need to send one. But if there is One, then if the code_type is REPEAT_NO_TERM (90) and it's a repeat time for transmitting the Main Sequence (91), then we skip the Terminator; otherwise, we transmit the Terminator by getting the next 4 bytes from code_tab and store them as next_on_time and next_off_time (92), and transmit them with send_on_off_times_to_gating_timer (93).

We have now finished sending the Main Sequence. So, no matter what, first_xmit_flag=FALSE (94), meaning that from now on it will no longer be the first transmission of the Main Sequence. We also decrement repeat_count (95), since we just repeated the Main Sequence once. And we can return with the task complete (96).

FIG. 10D shows a flow chart revealing the details of the xmit_hold_down_sequence subroutine. It does what it says. The Hold-Down sequence is always just a sequence of On-Time/Off-Time pairs stored in code_tab in the order they need to be transmitted. The Hold-Down Sequence is repeated REPEAT_COUNTS times. So, to send the Hold-Down sequence, we set repeat_count=REPEAT_COUNTS (97), get the number of On-Time/Off-Time pairs from code_tab (98), and grab the next 4 bytes from code_tab, which are the next On-Time/Off-Time pair (99), ready to be sent to the Gating Timer with send_on_off_times_to_gating_timer (100). Then we decrement num_pairs (101) and keep getting and transmitting On-Time/Off-Time pairs from code_tab until there are none left (102). At this point we've completed one transmission of the Hold-Down Sequence, so decrement repeat_count (103). If we repeated it enough times (104), then return (106), otherwise, we need to repeat the transmission of the Hold-Down Sequence, so reset code_tab_ptr to point to num_pairs in code_tab (105), and repeat the Hold-Down Sequence.

FIG. 10E shows the flow chart for the get_next_on_off_times subroutine. This subroutine does the job of retrieving the correct On-Time/Off-Time pair according to the qualities of the code_type that determine the structure of the code's entry in the database. Some or all of the values come from where the next nybble offset in the Sequence of Nybbles points to in time_tab. The subroutine returns with next_on_time and next_off_time containing the next On-Time/Off-Time pair to transmit for the Sequence, with code_tab_ptr pointing to the byte with the next nybble offset, with nyb_flag indicating which nybble of the byte is the pertinent one, and with num_seq_nybs decremented. The first thing this subroutine does is check to see if the code_type has a constant time value (107), because if it does, then either the On-Time or the Off-Time will be gotten from const_time (saved previously in the get_and_xmit_next_code subroutine). We'll assume that it's next_on_time (108). Then the point_to_next_time_tab_entry subroutine calculates the correct place in time_tab to get_next_off_time and stores it in time_tab_ptr (109). The details of get_next_off_time will be described later. Then we get 2 bytes from time_tab where time_tab_ptr points and store it in next_off_time (110). We assumed that the code_type was CONST_ON, so if it is actually CONST_OFF (111), then we need to swap the values for next_on_time and next_off_time (112) before returning (115). If the code_type does not have a constant time value (107), then we do things a little differently. We still call point_to_next_time_tab_entry (113) to calculate time_tab_ptr, but we retrieve 4 bytes from time_tab, which are next_on_time and next_off_time (114). Then we can return (115).

FIG. 10F is a flow chart for the point_to_next_time_tab_entry subroutine. This subroutine calculates the correct place in time_tab to retrieve the time value(s) pointed to by the next nybble in the Sequence of Nybbles. The subroutine returns with time_tab_ptr pointing to the correct spot in time_tab, with code_tab_ptr pointing to the byte in the Sequence of Nybbles that contains the next nybble offset, with nyb_flag indicating which of the 2 nybbles is the pertinent one, and with num_seq_nybs decremented. We enter this subroutine with code_tab_ptr pointing to the byte in the Sequence of Nybbles where the next nybble offset lives. The first thing we do is get that byte (116). We want to make sure that the pertinent nybble is in the Least Significant nybble of that byte and make code_tab_ptr and nyb_flag point to where the next nybble offset lives. If nyb_flag=MSnyb (117), then toggle nyb_flag to LSnyb (118) and swap the nybbles in the byte we just got (119) so that the pertinent nybble is in the Least Significant nybble of the byte—code_tab_ptr will remain the same because the next nybble offset lives in LSnyb of the same byte. If nyb_flag=LSnyb (117), then toggle nyb_flag to MSnyb (120) and increment code_tab_ptr to the next byte in the Sequence of Nybbles (121), since that's where the next nybble offset lives (in the MSnyb)—the current pertinent nybble offset is already in the Least Significant nybble of the byte we just got. So now, the current pertinent nybble offset is in the Least Significant nybble of the byte we just got, so mask off all but the Least Significant nybble of that byte (122). We can decrement num_seq_nybs (123) in anticipation of having gotten the time values (one less nybble in the Sequence of Nybbles to go). Calculate the correct place in time_tab (124) to retrieve the time value(s): time_tab_ptr=time_tab_beg+BYTE (the byte contains the nybble offset). The task is now complete, so we can return (125).

FIG. 10G is a flow chart for the start_gating_timer subroutine. This subroutine is used to start the Gating Timer with next_on_time and next_off_time when first starting the transmission of an encoded power signal. After returning from this subroutine, the Gating Timer is running, counting down the Off-Time, with its output Low, and ready for the next_on_time and next_off_time to be sent to it via send_on_off times_to_gating_timer. Upon entry, this subroutine loads the Gating Timer's 16-bit hold register with next_on_time (126) and starts the Gating Timer (127). This brings the Gating Timer's output High, thus sending the output of the Carrier Timer (whether it's a carrier or a static High) to the IR LEDs (through the internal AND gate, to the microcontroller's output). While the Gating Timer is counting down the On-Time, we load the Gating Timer's hold register with next_off_time (128) and wait for the On-Time to finish (129) (by polling for the Gating Timer's timeout flag to be set). When the On-Time finishes, the Gating Timer's output toggles to Low, thus gating off the Carrier Timer's output and the IR LEDs turn off; and simultaneously the Off-Time in the Gating Timer's hold register is automatically loaded into the timer, and it starts counting down. The subroutine returns (130) as the Off-Time is counting down.

FIG. 10H is a flow chart for the send_on_off_times_to_gating_timer subroutine. This subroutine is used to send next_on_time and next_off_time values to the Gating Timer once it's been started by start_gating_timer. The send_on_off_times_to_gating_timer subroutine is entered with an Off-Time counting down in the Gating Timer. While the Off-Time is counting down, the next_on_time is loaded into the Gating Timer's hold register (131) and we then wait for the Off-Time to finish (132) (by polling for the Gating Timer's timeout flag to be set). When the Off-Time finishes, the Gating Timer's output toggles to High (and the Carrier Timer's output is gated to the IR LEDs) and simultaneously the On-Time in the Gating Timer's hold register gets loaded into the Gating Timer and it starts counting down. While the On-Time is counting down we load the Gating Timer's hold register with the next_off_time (133), and then wait for the On-Time to finish (134) (by polling for the Gating Timer's timeout flag to be set). When the On-Time finishes, the Gating Timer's output toggles to Low, thus gating off the Carrier Timer's output and the IR LEDs turn off; and simultaneously the Off-Time in the Gating Timer's hold register is automatically loaded into the timer, and it starts counting down. The subroutine returns (135) as the Off-Time is counting down.

Those skilled in the art can readily implement the above firmware in the microcontroller's assembly language.

### How to Use the Device of the Present Invention

A person wears the 3″ diameter 1970s style “smiley-face” pin, which is a device of the present invention. If the person encounters a TV that is distracting or disturbing them, they press the “nose” of the smiley-face (which is actually a small push-button switch). This turns on the device of the present invention, which then goes through its entire database of encoded power signals, sending each in turn to the 2 IR LEDs which are the “eyes” of the smiley-face. As with any remote control, the wearer of a device of the present invention must make sure that the device is pointed towards the TV that they want to turn off (with nothing opaque to IR light blocking the signal). It takes about 1 minute to cycle through the entire database of encoded power signals, so within about 1 minute, the TV will be remotely turned off (assuming that the encoded power signal for that TV is stored in the device of the present invention's database). After cycling through the entire sequence of encoded power signals, the device of the present invention turns itself off. The device of the present invention's batteries should have a life of several months with normal use (depending on how many times it's necessary for a wearer of the device of the present invention to use the device of the present invention).

What is claimed is:

1. A method for effecting a function of a remotely controlled television, comprising:
pointing a universal remote device in the direction of the remotely controlled television, said universal remote device comprising a database of encoded signals for effecting the function on at least twenty different remotely controlled televisions each of said at least twenty different remotely controlled televisions requiring a different signal to effect said function, and wherein the signal required to effect the function on said television is not known prior to encountering it;
actuating an actuator on the universal remote device, thereby causing the device to send the encoded signals for the at least twenty different televisions from the database to a signal emitter on the universal remote device; and
sequentially emitting the encoded signals from the signal emitter so as to effect the function on said one of the remotely controlled televisions without selecting a set of encoded signals for the universal remote device, wherein there is no more than about ½ second between each encoded signal.

2. The method of claim 1, wherein the encoded signals are sent only a single time to the signal emitter.

3. The method of claim 1, wherein the signals emitted are infrared light.

4. The method of claim 1, further comprising pointing the universal remote device in the direction of a second remotely controlled television and repeating the actuating and emitting steps.

5. The method of claim 1, wherein the function effected is powering off the device.

6. The method of claim 1, wherein the function effected is muting the device.

7. The method of claim 1, further comprising pointing the universal remote device in the direction of the same one of the remotely controlled televisions a second time and repeating the actuating and emitting steps.

8. The method of claim 7, wherein the function is reversed upon repeating the actuating and emitting steps.

9. The method of claim 8, wherein the remotely controlled television is turned on when the function is reversed.

10. The method of claim 1, wherein the encoded signals are emitted with between about ¼ second and ½ second between each encoded signal.

11. The method of claim 1, wherein the device controls no more than two functions, wherein the functions are selected from the group consisting of power on/off, mute and closed caption.

12. A method for minimizing disturbance from a remotely controlled television in a place where there are a plurality of televisions, comprising:
encountering the television in the place where there are a plurality of televisions;
pointing a universal remote device in the direction of the remotely controlled television, said universal remote device comprising a database of encoded signals for effecting a function selected from the group consisting of power on/off and mute on at least twenty different remotely controlled televisions, each of said at least twenty different remotely controlled televisions requiring a different signal to effect said function, wherein the signal required to effect the function on said television is not known prior to encountering it;
actuating an actuator on the universal remote device, thereby causing the device to send the encoded signals for the at least twenty different remote controlled televisions from the database to a signal emitter on the universal remote device;
sequentially emitting the encoded signals from the signal emitter so as to effect the function on said television in the public place, thereby minimizing disturbance from the television in the public place, wherein there is no more than about ½ second between each encoded signal.

13. The method of claim 1, wherein each encoded signal is sent only once.

14. The device of claim 1, wherein the function effected is closed caption.
